(19) United States
(12) Patent Application Publication
(10) Pub. No.: US 2024/0323773 A1
(43) Pub. Date: Sep. 26, 2024

(54) CONTROL OF CONDITIONAL SECONDARY NODE ADDITION

(71) Applicant: Telefonaktiebolaget LM Ericsson (PUBL), Stockholm (SE)

(72) Inventors: Icaro Leonardo Da Silva, SOLNA (SE); Cecilia Eklöf, TÄBY (SE); Julien Muller, RENNES (FR)

(21) Appl. No.: 18/261,025

(22) PCT Filed: Jan. 14, 2022
(86) PCT No.: PCT/SE2022/050038

§ 371 Date: Jul. 11, 2023

Related U.S. Application Data
(60) Provisional application No. 63/137,651, filed on Jan. 14, 2021.

(51) Int. Cl. H04W 36/00; H04W 36/08

(52) U.S. Cl. CPC H04W 36/0061; H04W 36/0058; H04W 36/08

(57) ABSTRACT

According to certain embodiments, a method (1800) by a MN (160, 54, 64) includes transmitting (1802), to a T-SN (160, 56, 66), a request message requesting the addition or modification of the T-SN. The message indicates at least one of a number of requested PSCells to be configured by the T-SN and a maximum number of PSCells to be configured by the T-SN. The MN receives, from the T-SN, an indication of a plurality of target candidate PSCell configurations to configure for a wireless device (110, 52, 62).

### TECHNICAL FIELD

The present disclosure relates, in general, to wireless communications and, more particularly, systems and methods for control of conditional secondary node addition for both Conditional Primary Secondary Cell Addition (CPA) and Conditional Primary Secondary Cell Change (CPC).

### BACKGROUND

Two work items for mobility enhancements in LTE and NR are discussed in 3GPP in Release 16. The main objectives of the work items are to improve the robustness at handover (HO) and to decrease the interruption time at HO.

One problem related to robustness at HO is that the HO Command (RRCConnectionReconfiguration with mobilityControlInfo and RRCReconfiguration with a reconfigurationWithSync field) is normally sent when the radio conditions for the user equipment (UE) are already quite bad. As a result, if the message is segmented or there are retransmissions, the HO Command may not reach the UE in time.

In Long Term Evolution (LTE) and New Radio (NR), different solutions have been discussed to increase mobility robustness. One solution for NR is called conditional handover (CHO) or early handover command. In order to avoid the undesired dependence on the serving radio link upon the time (and radio conditions) where the UE should execute the HO, the possibility of providing Radio Resource Control (RRC) signaling for the HO to the UE earlier has been discussed. To achieve this, it should be possible to associate the HO command with a condition. As soon as the condition is fulfilled, the UE executes the HO in accordance with the provided HO command.

The condition associated with the HO command may be based on radio conditions similar to those associated with an A3 event. Such a condition could, for example, be that the quality of the target cell or beam becomes X dB stronger than the serving cell. The threshold Y used in a preceding measurement reporting event should then be chosen lower than the one in the HO execution condition. This allows the serving cell to prepare the HO upon reception of an early measurement report and to provide the RRCConnectionReconfiguration with mobilityControlInfo at a time when the radio link between the source cell and the UE is still stable. The execution of the HO is done at a later point in time (and threshold) which is considered optimal for the HO execution.

FIG. 1 illustrates an example of conditional handover (CHO) execution in a scenario with only a serving and a target cell. In practice, there may be many cells or beams that the UE reports as possible candidates based on its preceding Radio Resource Management (RRM) measurements. The network should then have the freedom to issue CHO commands for several of those candidates. The RRCConnectionReconfiguration for each of those candidates may differ e.g. in terms of the HO execution condition (Reference Signal (RS) to measure and threshold to exceed) as well as in terms of the Random Access (RA) preamble to be sent when a condition is met.

While the UE evaluates the condition, it should continue operating per its current RRC configuration, i.e., without applying the CHO command. When the UE determines that the condition is fulfilled, it disconnects from the serving cell, applies the CHO command and connects to the target cell. These steps are equivalent to the current, instantaneous handover execution. Additionally details relating to CHO is described in Chapter 9.2.3.4 of 3GPP TS 38.300 in chapter 9.2.3.4.

FIG. 2 illustrates a signaling diagram for Intra-AMF/UPF CHO as discussed in 3GPP TS 38.300 in chapter 9.2.3.4.2. As depicted in FIG. 2, the steps for CHO may include:
0/1. Same as step 0, 1 in FIG. 9.2.3.2.1-1 of section 9.2.3.2.1.
2. The source gNB decides to use CHO.
3. The source gNB issues a Handover Request message to one or more candidate gNBs.
4. Same as step 4 in FIG. 9.2.3.2.1-1 of section 9.2.3.2.1.
5. The candidate gNB sends HANDOVER REQUEST ACKNOWLEDGE message including configuration of CHO candidate cell to the source gNB.
6. The source gNB sends an RRCReconfiguration message to the UE, containing the configuration of CHO candidate cell(s) and CHO execution condition(s).
7. UE sends an RRCReconfigurationComplete message to the source gNB.
8. UE maintains connection with source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronises to that candidate cell and completes the RRC handover procedure by sending RRCReconfigurationComplete message to the target gNB. The UE releases stored CHO configurations after successful completion of RRC handover procedure.

### Primary Secondary Cell (PSCell) Addition

The UE can be configured with Dual Connectivity (DC), communicating both via an Master Cell Group (MCG) and a Secondary Cell Group (SCG). When the UE is configured with DC, the UE is configured with two Medium Access Control (MAC) entities: one MAC entity for the MCG and one MAC entity for the SCG. In Multi-Radio DC (MR-DC) the cell groups are located in two different logical nodes, i.e. different Next Generation-Radio Access Network (NG-RAN) nodes, possibly connected via a non-ideal backhaul, one providing NR access and the other one providing either Evolved-Universal Terrestrial Radio Access (E-UTRA) or NR access. One node acts as the Master Node (MN) and the other acts as the Secondary Node (SN). The MN and SN are connected via a network interface and at least the MN is connected to the core network (CN). The operation in MR-DC involves different reconfiguration procedures, like SN addition, SN modification, SN release, and SN change.

### SN Addition

The SN Addition procedure is initiated by the MN and is used to establish a UE context at the SN in order to provide resources from the SN to the UE. For bearers requiring SCG radio resources, this procedure is used to add at least the initial SCG serving cell of the SCG. This procedure can also be used to configure an SN terminated MCG bearer where no SCG configuration is needed.

FIG. 3 illustrates the SN addition procedure as discussed in 3GPP TS 37.340, which leads to a PSCell Change addition. As depicted in FIG. 3, the steps for the SN addition procedure may include:
1. The MN decides to request the Target SN (T-SN) to allocate resources for one or more specific Protocol Data Unit (PDU) Sessions/Quality of Service (QOS) Flows, indicating QoS Flows characteristics (QOS Flow Level QoS parameters, PDU session level Transport Network Layer (TNL) address information, and PDU session level Network Slice info). In addition, for bearers requiring SCG radio resources, MN indicates the requested SCG configuration information, including the entire UE capabilities and the UE capability coordination result. In this case, the MN also provides the latest measurement results for SN to choose and configure the SCG cell(s). The MN may request the SN to allocate radio resources for split Signaling Radio Bearer (SRB) operation. In Next Generation-Dual Connectivity (NGEN-DC) and New Radio-Dual Connectivity (NR-DC), the MN always provides all the needed security information to the SN (even if no SN terminated bearers are setup) to enable SRB3 to be setup based on SN decision.
   For MN terminated bearer options that require Xn-U resources between the MN and the SN, the MN provides Xn-U uplink (UL) Transport Network Layer (TNL) address information. For SN terminated bearers, the MN provides a list of available Data Radio Bearer Identifiers (DRB IDs). The Secondary-Next Generation-Radio Access Network (S-NG-RAN) node shall store this information and use it when establishing SN terminated bearers. The SN may reject the request.
   For SN terminated bearer options that require Xn-U resources between the MN and the SN, the MN provides in step 1 a list of QoS flows per PDU Sessions for which SCG resources are requested to be setup upon which the SN decides how to map QoS flows to DRB.
   It may be noted that, for split bearers, MCG and SCG resources may be requested of such an amount, that the QoS for the respective QoS Flow is guaranteed by the exact sum of resources provided by the MCG and the SCG together, or even more. For MN terminated split bearers, the MN decision is reflected in step 1 by the QoS Flow parameters signalled to the SN, which may differ from QoS Flow parameters received over NG.
   It may be further noted that, for a specific QoS flow, the MN may request the direct establishment of SCG and/or split bearers, i.e. without first having to establish MCG bearers. It is also allowed that all QoS flows can be mapped to SN terminated bearers, i.e. there is no QoS flow mapped to an MN terminated bearer.
2. If the Radio Resource Management (RRM) entity in the SN is able to admit the resource request, it allocates respective radio resources and, dependent on the bearer type options, respective transport network resources. For bearers requiring SCG radio resources, the SN triggers UE Random Access so that synchronisation of the SN radio resource configuration can be performed. The SN decides for the PSCell and other SCG SCells and provides the new SCG radio resource configuration to the MN within an SN RRC configuration message contained in the SN Addition Request Acknowledge message. In case of bearer options that require Xn-U resources between the MN and the SN, the SN provides Xn-U TNL address information for the respective DRB, Xn-U UL TNL address information for SN terminated bearers, Xn-U DL TNL address information for MN terminated bearers. For SN terminated bearers, the SN provides the NG-U DL TNL address information for the respective PDU Session and security algorithm. If SCG radio resources have been requested, the SCG radio resource configuration is provided.
   It is noted that, in case of MN terminated bearers, transmission of user plane data may take place after step 2. In case of SN terminated bearers, data forwarding and the SN Status Transfer may take place after step 2.
   For MN terminated NR SCG bearers for which Packet Data Convergence Protocol (PDCP) duplication with Carrier Aggregation (CA) is configured the MN allocates 2 separate Xn-U bearers. For SN terminated NR MCG bearers for which PDCP duplication with CA is configured the SN allocates 2 separate Xn-U bearers.
2a. For SN terminated bearers using MCG resources, the MN provides Xn-U DL TNL address information in the Xn-U Address Indication message.
3. The MN sends the MN RRC reconfiguration message to the UE including the SN RRC configuration message, without modifying it.
4. The UE applies the new configuration and replies to MN with MN RRC reconfiguration complete message, including an SN RRC response message for SN, if needed. In case the UE is unable to comply with (part of) the configuration included in the MN RRC reconfiguration message, it performs the reconfiguration failure procedure.
5. The MN informs the SN that the UE has completed the reconfiguration procedure successfully via SN Reconfiguration Complete message, including the SN RRC response message, if received from the UE.
6. If configured with bearers requiring SCG radio resources, the UE performs synchronisation towards the PSCell configured by the SN. The order the UE sends the MN RRC reconfiguration complete message and performs the Random Access procedure towards the SCG is not defined. The successful Random Access (RA) procedure towards the SCG is not required for a successful completion of the RRC Connection Reconfiguration procedure.
7. If PDCP termination point is changed to the SN for bearers using Radio Link Control (RLC) Acknowledge Mode (AM), and when RRC full configuration is not used, the MN sends the SN Status Transfer.
8. For SN terminated bearers or QoS flows moved from the MN, dependent on the characteristics of the respective bearer or QOS flow, the MN may take actions to minimise service interruption due to activation of Multi-RAT-Dual Connectivity (MR-DC) (Data forwarding).
9-12. If applicable, the update of the User Plane (UP) path towards the 5^{th} Generation Core (5GC) is performed via a PDU Session Path Update procedure.

### Conditional PSCell Change (CPC) Rel-16

A solution for Conditional PSCell Change (CPC) procedure was standardized in Rel-16. Therein, a UE operating in MR-DC receives in a conditional reconfiguration one or multiple RRC Reconfiguration(s) (e.g. an RRCReconfiguration message) containing an SCG configuration (e.g. an secondaryCellGroup of IE CellGroupConfig) with a reconfiguration WithSync that is stored and associated to an execution condition (e.g. a condition like an A3/A5 event configuration), so that one of the stored messages is only applied upon the fulfillment of the execution condition e.g. associated with the serving PSCell, upon which the UE would perform PSCell change (in case it find a neighbour cell that is better than the current Special Cell (SpCell) of the SCG).

In Rel-16 CPC will be supported, but in Rel-17 also PSCell Addition will be included, i.e. Conditional PSCell Addition/Change (CPAC). In Rel-16 only intra-SN CPC without MN involvement is standardized. Inter SN PSCell CPC and CPC with MN involvement will be included in Rel-17.

As described above, in Rel-16, only the intra-SN case without MN involvement for CPC is supported, i.e. where S-SN and T-SN are the same node. That means that, though the cell is changed, both the old and the new cell are in the same node.

Certain problems exist, however. For example, in previous techniques for PSCell Addition or MN-initiated PSCell change, the MN requests only one target PSCell from the target SN. However, in RAN2 #112e, it has been agreed for both CPA and SN-initiated inter-SN CPC that support should be provided for configuration of one or more candidate cells for CPAC.

Thus, with Rel-17 CPAC, the MN may be able to request one or more target candidate PSCells to be configured by a target candidate SN. Also, the target candidate SN is in charge of selecting the target candidate PSCell(s) to configure such as, for example, based on measurements (and possibly other information such as PCell ID) received from the MN in the SN Addition Request.

By requesting in a single message multiple target candidate cells, the MN does not know how many target candidate PSCells would be prepared by a given T-SN. Likewise, there is no mechanism in the current specification which can be used by the MN to limit or otherwise control the number of PSCells configured by the target candidate SN.

Another issue is that the MN may configure multiple target candidate SNs for the same UE, and there is a maximum number of candidate target cells that can be configured totally in RRC signalling. Currently, the maximum number of candidate target cells is limited to eight. But, the T-SNs do not know how many CPA configurations were configured by the other SNs and, therefore, may configure a number of PSCells that exceeds the UE limitation when added to the other target candidate SN PSCells.

### SUMMARY

Certain aspects of the present disclosure and their embodiments may provide solutions to these or other challenges. For example, according to certain embodiments, methods, systems, and techniques are provided that enable a MN to control the number of target candidate cells for CPAC that are requested to a target candidate SN by, for example, indicating a maximum number.

According to certain embodiments, a method by a MN includes transmitting, to a T-SN, a request message requesting the addition or modification of the T-SN. The message indicates at least one of a number of requested PSCells to be configured by the T-SN and a maximum number of PSCells to be configured by the T-SN. The MN receives, from the T-SN, an indication of a plurality of target candidate PSCell configurations to configure for a wireless device.

According to certain embodiments, a MN is adapted to transmit, to a T-SN, a request message requesting the addition or modification of the T-SN. The message indicates at least one of a number of requested PSCells to be configured by the T-SN and a maximum number of PSCells to be configured by the T-SN. The MN is adapted to receive, from the T-SN, an indication of a plurality of target candidate PSCell configurations to configure for a wireless device.

According to certain embodiments, a method by a T-SN includes receiving, from a MN, a message requesting the addition or modification of the target secondary node. The message indicates at least one of a number of requested PSCells to be configured by the T-SN and a maximum number of PSCells to be configured by the T-SN. In response to the message, the T-SN transmits, to the MN, an indication of a plurality of target candidate PSCell configurations to configure for a wireless device.

According to certain embodiments, a T-SN is adapted to receive, from a MN, a message requesting the addition or modification of the target secondary node. The message indicates at least one of a number of requested PSCells to be configured by the T-SN and a maximum number of PSCells to be configured by the T-SN. In response to the message, the T-SN is adapted to transmit, to the MN, an indication of a plurality of target candidate PSCell configurations to configure for a wireless device.

According to certain embodiments, a method by a MN includes receiving, from a T-SN a number of target candidate PSCell configurations. The MN determines whether the number of target candidate PSCell configurations exceeds a maximum number of target candidate PSCell configurations and takes at least one action based on whether the number of target candidate PSCell configurations exceeds the maximum number of target candidate PSCell configurations.

According to certain embodiments, a MN is adapted to receive, from a T-SN a number of target candidate PSCell configurations. The MN is adapted to determine whether the number of target candidate PSCell configurations exceeds a maximum number of target candidate PSCell configurations and take at least one action based on whether the number of target candidate PSCell configurations exceeds the maximum number of target candidate PSCell configurations.

According to certain embodiments, a method by a T-SN includes receiving, from a MN, a SN addition request and transmitting a number of target candidate PSCell configurations to the MN. The number of target candidate PSCell configurations is based on at least one of: a content of the SN addition request, a configuration of the T-SN, and a load of the T-SN.

According to certain embodiments, a T-SN is adapted to receive, from a MN, a SN addition request and transmit a number of target candidate PSCell configurations to the MN. The number of target candidate PSCell configurations is based on at least one of: a content of the SN addition request, a configuration of the T-SN, and a load of the T-SN.

Certain embodiments may provide one or more of the following technical advantages. For example, one technical advantage may be that certain embodiments enable the MN to control the number of PSCells configured by the target candidate SN during CPAC. As such, a technical advantage may that the MN is able to control the total number of candidate target cells configured towards the UE.

As another example, a technical advantage of certain embodiments may be that UE capability, in terms of the number of target candidate cells configured for CPAC, will not be exceeded during CPAC configuration. This may prevent the UE from declaring a reconfiguration failure and triggering a re-establishment procedure.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of conditional handover (CHO) execution in a scenario with only a serving and a target cell;

FIG. 2 illustrates a signaling diagram for Intra-AMF/UPF CHO as discussed in 3GPP TS 38.300 in chapter 9.2.3.4.2;

FIG. 3 illustrates the SN addition procedure as discussed in 3GPP TS 37.340;

FIG. 4 illustrates a signalling diagram for conditional PSCell Addition, according to certain embodiments;

FIG. 5 illustrates another signalling diagram for conditional PSCell Addition, according to certain embodiments;

FIG. 6 illustrates an example wireless network, according to certain embodiments;

FIG. 7 illustrates an example network node, according to certain embodiments;

FIG. 8 illustrates an example wireless device, according to certain embodiments;

FIG. 9 illustrate an example user equipment, according to certain embodiments;

FIG. 10 illustrates a virtualization environment in which functions implemented by some embodiments may be virtualized, according to certain embodiments;

FIG. 11 illustrates a telecommunication network connected via an intermediate network to a host computer, according to certain embodiments;

FIG. 12 illustrates a generalized block diagram of a host computer communicating via a base station with a user equipment over a partially wireless connection, according to certain embodiments;

FIG. 13 illustrates a method implemented in a communication system, according to one embodiment;

FIG. 14 illustrates another method implemented in a communication system, according to one embodiment;

FIG. 15 illustrates another method implemented in a communication system, according to one embodiment;

FIG. 16 illustrates another method implemented in a communication system, according to one embodiment;

FIG. 17 illustrates an example method depicts by a first network node operating as a MN, according to certain embodiments;

FIG. 18 illustrates an example virtual apparatus, according to certain embodiments;

FIG. 19 illustrates an example method by a first network node operating as a T-SN, according to certain embodiments;

FIG. 20 illustrates another example virtual apparatus, according to certain embodiments;

FIG. 21 illustrates another example method by a first network node operating as a MN, according to certain embodiments;

FIG. 22 illustrates another example virtual apparatus, according to certain embodiments;

FIG. 23 illustrates another example method by a first network node operating as a T-SN, according to certain embodiments;

FIG. 24 illustrates another example virtual apparatus, according to certain embodiments;

FIG. 25 illustrates another example method by a MN, according to certain embodiments;

FIG. 26 illustrates another example method by a T-SN, according to certain embodiments;

FIG. 27 illustrates another example method by a MN, according to certain embodiments; and

FIG. 28 illustrates another example method by a T-SN, according to certain embodiments.

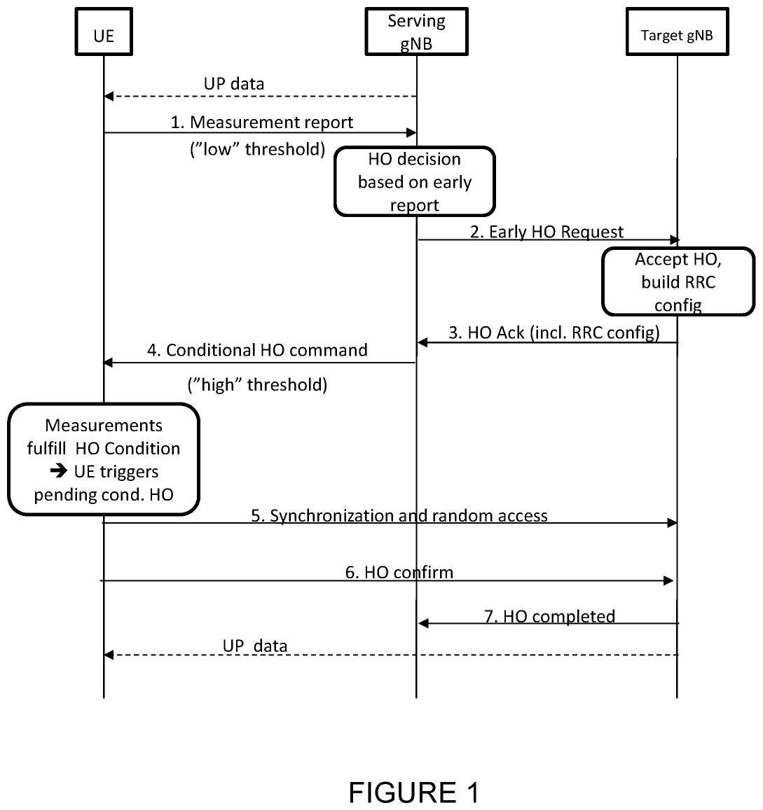

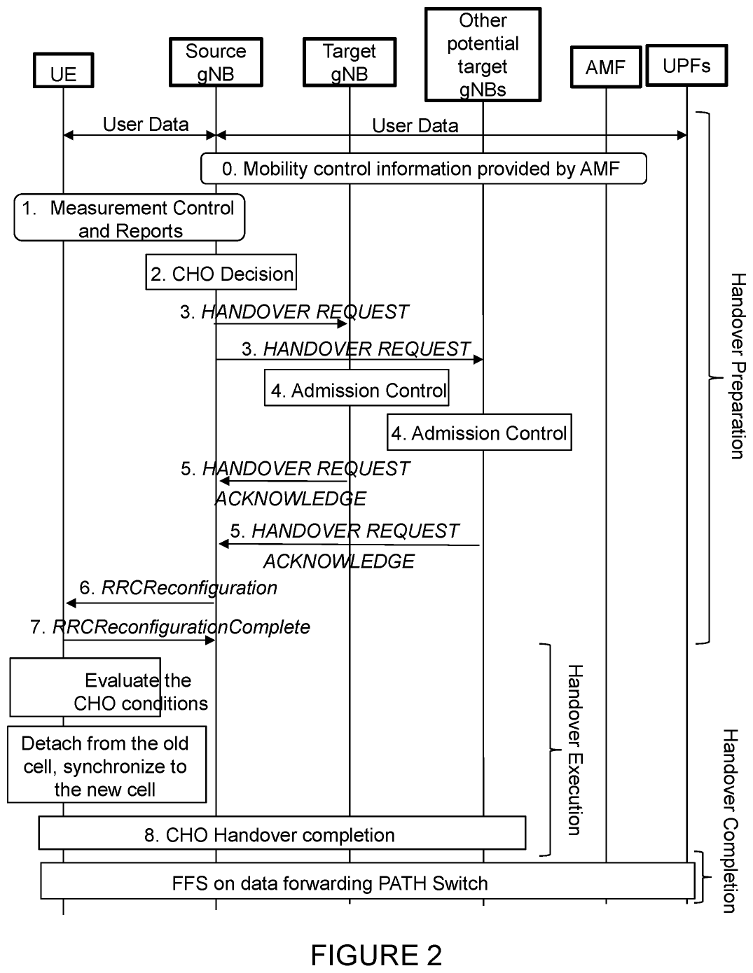

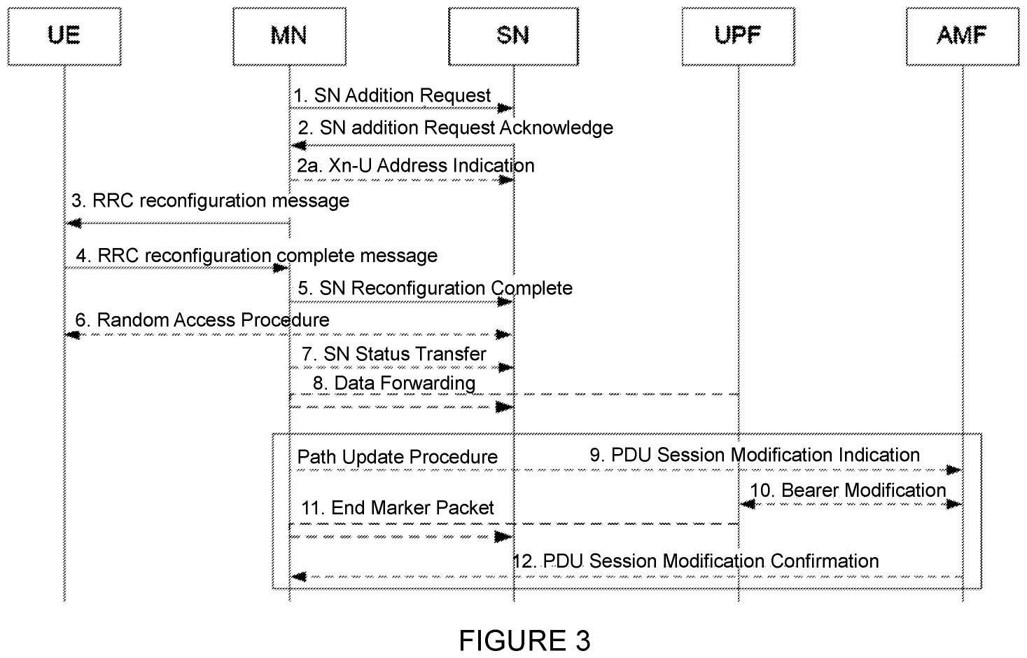

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU. RRH, nodes in distributed antenna system (DAS), core network node (e.g. MSC. MME, etc.), O&M, OSS. SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

Certain embodiments refer to a UE operating in Multi-Radio Dual Connectivity (MR-DC) according to the NR specifications e.g. 3GPP TS 37.340, 3GPP TS 38.331, etc. Certain embodiments may refer to a first network node operating as a Master Node (MN), e.g. having a Master Cell Group (MCG) configured to the UE and/or an MN-terminated bearer; that MN can be a gNodeB, or a Central Unit gNodeB (CU-gNB) or an eNodeB, or a Central Unit eNodeB (CU-gNB), or any network node and/or network function.

Certain embodiments may also refer to a second network node operating as a Secondary Node (SN), or Source Secondary Node (S-SN) e.g. having a Secondary Cell Group (SCG) configured to the UE and/or an SN-terminated bearer; that SN can be a gNodeB, or a Central Unit gNodeB (CU-gNB) or an eNodeB, or a Central Unit eNodeB (CU-gNB), or any network node and/or network function. Notice that MN, S-SN and T-SN may be from the same or different Radio Access Technologies (and possibly be associated to different Core Network nodes).

Certain embodiments described herein may refer to a target candidate SN, or T-SN candidate, or an SN, or SN candidate or candidate SN, as the network node (e.g. gNodeB) that is prepared during the CPA procedure and that creates an RRC Reconfiguration message with an SCG configuration (e.g. RRCReconfiguration**) to be provided to the UE and stored, with an execution condition, wherein the UE only applies the message upon the fulfillment of the execution condition. That target candidate SN (or simply T-SN candidate) is associated to one or multiple target PSCell candidate cell(s) that the UE can be configured with. The UE then can execute the condition and accesses one of these target candidate cells, associated to a T-SN candidate that becomes the T-SN or simply the SN after execution (i.e. upon fulfillment of the execution condition).

Certain embodiments refer to a Conditional PSCell Change (CPC) and/or Conditional PSCell Addition (CPA) and/or Conditional PSCell Change/Addition (CPAC) configuration and procedures (like CPAC execution). Other terms may be considered as synonyms such as conditional reconfiguration, or Conditional Configuration (since the message that is stored and applied upon fulfillment of a condition is an RRCReconfiguration or RRCConnectionReconfiguration). Terminology wise, one could also interpret conditional handover (CHO) in a broader sense, also covering CPC (Conditional PSCell Change) or CPAC (Conditional PSCell Addition/Change) procedures.

The conditional SN Addition Request can be an SN Addition Request message including an indication that this is for Conditional PSCell Addition. In that case, the MN has determined to configure CPA based on measurements reported by the UE including measurements of neighbour cells that may be configured as target candidate cells.

The configuration of CPA can be done using the same Information Elements (IEs) as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs are disclosed in 3GPP TS 38.331 v. 16.3.1.

As used herein, the terms handover, reconfiguration WithSync, PSCell change are used in the same context.

As described below, certain embodiments are described in terms of inter-node signaling and inter-node procedures to configure MN initiated conditional PSCell Addition (CPA) and/or MN initiated conditional PSCell Change (CPC).

For example, according to certain embodiments, methods, systems, and techniques are provided that enable a MN to control the number of target candidate cells for CPAC that are requested to a T-SN candidate by, for example, indicating a maximum number.

According to certain embodiments, the methods, systems, and techniques are provided to enable a T-SN candidate receiving a request to add/prepare target candidate cells for CPAC (e.g. by generating an RRCReconfiguration for PSCell Addition or PSCell Change to be applied by the UE upon the fulfillment of an execution condition) to determine up to how many target candidates are to be prepared and provided to the MN.

According to certain embodiments, the methods, systems, and techniques are applied where the MN requests, in a single message, CPAC for multiple target cell candidates to a given SN. This becomes even more relevant if the MN may send requests for more than one SN target candidate and each T-SN candidate is not aware of what may have been previously configured for other T-SN candidate(s). Certain and/or particular embodiments cover both cases: i) MN-initiated Conditional PSCell Change (CPC); ii) Conditional PSCell Addition (CPA).

According to certain embodiments, for example, a method by a network node operating as a Master Node (MN) includes:
sending a conditional SN Addition Request to a T-SN candidate to prepare one or multiple candidate PSCells. This request may contain at least one of the following or a combination of these:
   The number of requested PSCells to be configured by the T-SN candidate,
   A maximum number of PSCells to be configured by the T-SN candidate;
   The number or maximum number of cells can be expressed as an integer value e.g. N=5. Alternatively, that can be expressed implicitly by the number of cells for which measurements are provided in the conditional SN Addition Request. For example, if the MN determines that only 5 target PSCell candidates are to be configured for CPAC by the T-SN candidate, the MN includes measurements for 5 cells (e.g. possibly per carrier frequency, to take carrier aggregation into account, or at least limit the number for the frequency aimed to be the PSCell frequency).
   The conditional SN Addition Request can be an SN Addition Request message including an indication that this is for Conditional PSCell Change.
      In one option, this is triggered by the MN in case of an MN-initiated Conditional PSCell Change (CPC).
      In another option, this is triggered by the Source SN in case of an SN-initiated Conditional PSCell Change (CPC) e.g. the MN receiving an SN CHANGE REQUIRED for CPC.
   receiving the response to the SN Addition Request from the T-SN candidate, containing one or more target candidate PSCell configurations;
   checking that the number of PSCell configurations does not exceed any limitation (e.g. UE); If the limit is exceeded, sending a request to the T-SN candidate cancelling one or multiple PSCell configurations; and
   sending all or part of the PSCell configurations to the UE.

According to certain embodiments, for example, a method by a network node operating as a T-SN candidate includes:
receiving a conditional SN Addition Request from a MN to prepare one or multiple candidate PSCells. This request may contain:
   the number of requested PSCells to be configured, and/or
   a maximum number of PSCells to be configured; and
sending the response to the conditional SN Addition Request to the MN, containing one or more target candidate PSCell configurations. The exact number of PSCell configurations depends on the detail of the request such as, for example, the maximum number of PSCells, but also on internal T-SN candidate configuration and load; and
optionally, receiving a request from the MN cancelling one or multiple PSCell configurations.

According to certain other embodiments, a method by a network node operating as a Master Node (MN) includes:
sending a conditional SN Addition Request to a T-SN candidate to prepare one or multiple candidate PSCells
receiving the response to the conditional SN Addition Request from the T-SN candidate, containing one or more target candidate PSCell configurations, where the priority of the configurations is indicated, either implicitly (e.g. by sorting the cells in order of priority, such as the highest priority coming first) or explicitly (e.g. by defining an integer indicating the priority of a given target candidate cell);
determining which target cells to choose and configure towards the UE, the determination e.g. based on the indicated priority and or based on UE measurements. Sending a request to the T-SN candidate cancelling one or multiple PSCell configurations; and
sending all or part of the PSCell configurations to the UE.

According to certain other embodiments, for example, a method by a network node operating as a T-SN candidate includes:
-receiving a conditional SN Addition Request from a MN to prepare one or multiple candidate PSCells, and
sending the response to the CPA request to the MN, containing one or more target candidate PSCell configurations, the priority of the configurations indicated, either implicitly or explicitly, and
optionally, receiving a request from the MN cancelling one or multiple PSCell configurations.

### MN Indicates Number of Candidate Target Cells to the SN

According to certain embodiments, a first network node operating as MN determines to configure CPA for a UE operating in MR-DC. Upon determining to configure CPA, the first network node transmits a request to a T-SN indicating that CPA is to be configured for a given UE.

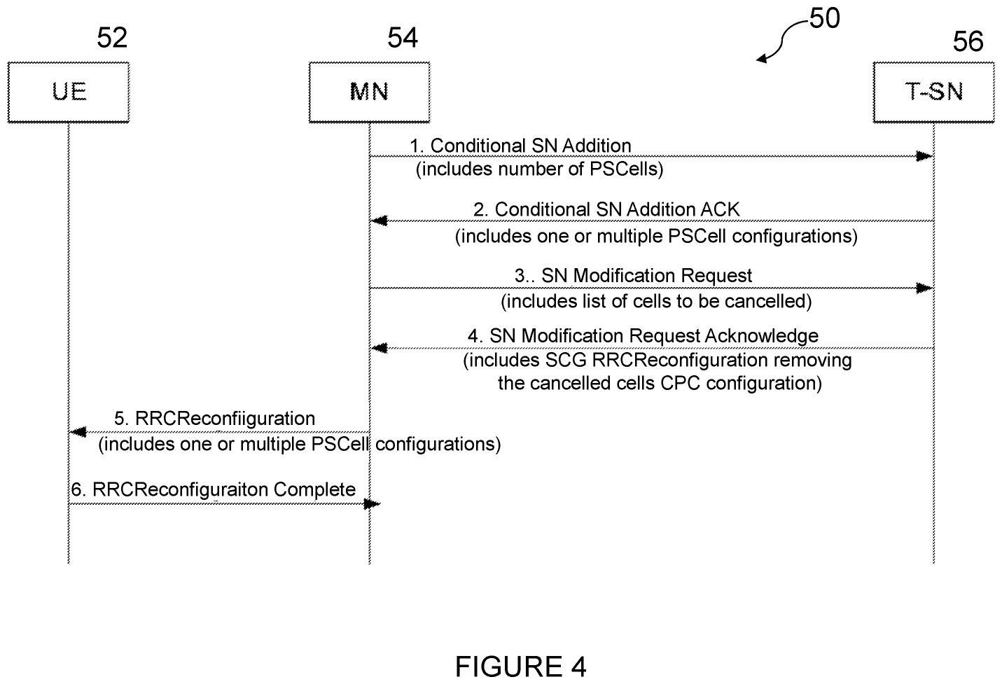

FIG. 4 illustrates a signalling diagram 50 for conditional PSCell Addition, according to certain embodiments. As depicted in FIG. 4, in a step 1, the node operating as MN 54 for a UE 52 operating in MR-DC sends to the Target Secondary Node (T-SN) 56 an S-NODE ADDITION REQUEST message including the maximum number of PSCells which can be configured for the UE, and an indication this SN Addition is for CPAC. In another embodiment, the MN includes the number of requested PSCells for that UE instead. The S-NODE ADDITION REQUEST is given as an example. The message between the MN and the T-SN can also be a new message such as a Conditional SN Addition.

An example of an enhanced version of the S-NODE ADDITION REQUEST as disclosed in Section 9.1.2.1 of 3GPP TS 38.423 but modified according to the method described herein is shown below. In this example, the indicator indicates the maximum number of PSCells which can be configured for the UE.

9.1.2.1 S-Node Addition Request This message is sent by the M-NG-RAN node to the S-NG-RAN node to request the preparation of resources for dual connectivity operation for a specific UE. Direction: M-NG-RAN node->S-NG-RAN node.

| | | | IE type and | Semantics |
|---|---|---|---|---|
| IE/Group Name | Presence | Range | reference | description |
| Message Type | M | | 9.2.3.1 | |
| M-NG-RAN node UE | M | | NG-RAN | Allocated at the M- |
| XnAP ID | | | node UE | NG-RAN node |
| | | | XnAP ID | |
| | | | 9.2.3.16 | |
| UE Security | M | | 9.2.3.49 | |
| Capabilities | | | | |
| S-NG-RAN node | M | | 9.2.3.51 | |
| Security Key | | | | |
| S-NG-RAN node UE | M | | UE | The UE Aggregate |
| Aggregate Maximum | | | Aggregate | Maximum Bit Rate |
| Bit Rate | | | Maximum | is split into M-NG- |
| | | | Bit Rate | RAN node UE |
| | | | 9.2.3.17 | Aggregate |
| | | | | Maximum Bit Rate |
| | | | | and S-NG-RAN |
| | | | | node UE Aggregate |
| | | | | Maximum Bit Rate |
| | | | | which are enforced |
| | | | | by M-NG-RAN node |
| | | | | and S-NG-RAN |
| | | | | node respectively. |
| Selected PLMN | O | | PLMN | The selected PLMN |
| | | | Identity | of the SCG in the S- |
| | | | 9.2.2.4 | NG-RAN node. |
| Mobility Restriction | O | | 9.2.3.53 | |
| List | | | | |
| Index to | O | | 9.2.3.23 | |
| RAT/Frequency | | | | |
| Selection Priority | | | | |
| PDU Session | | 1 | | |
| Resources To Be | | | | |
| Added List | | | | |
| >PDU Session | | 1 . . . | | NOTE: If neither the |
| Resources To Be | | <maxnoofPDUSessions> | | PDU Session |
| Added Item | | | | Resource Setup Info - |
| | | | | SN terminated IE |
| | | | | nor the |
| | | | | PDU Session |
| | | | | Resource Setup Info - |
| | | | | MN terminated IE |
| | | | | is present in a PDU |
| | | | | Session Resources |
| | | | | To Be Added Item |
| | | | | IE, abnormal |
| | | | | conditions as |
| | | | | specified in clause |
| | | | | 8.3.1.4 apply. |
| >>PDU Session ID | M | | 9.2.3.18 | |
| >>S-NSSAI | M | | 9.2.3.21 | |
| >>S-NG-RAN node | O | | PDU | |
| PDU Session | | | Session | |
| Aggregate | | | Aggregate | |
| Maximum | | | Maximum | |
| Bit Rate | | | Bit Rate | |
| | | | 9.2.3.69 | |
| >>PDU Session | O | | 9.2.1.5 | |
| Resource Setup Info - | | | | |
| SN terminated | | | | |
| >>PDU Session | O | | 9.2.1.7 | |
| Resource Setup Info - | | | | |
| MN terminated | | | | |
| M-NG-RAN node to S- | M | | OCTET | Includes the CG- |
| NG-RAN node | | | STRING | ConfigInfo message |
| Container | | | | as defined in |
| | | | | subclause 11.2.2 |
| | | | | of TS 38.331 [10] |
| S-NG-RAN node UE | O | | NG-RAN | Allocated at the |
| XnAP ID | | | node UE | S-NG-RAN node |
| | | | XnAP ID | |
| | | | 9.2.3.16 | |
| Expected UE Behaviour | O | | 9.2.3.81 | |
| Requested Split SRBs | O | | ENUMERATED | Indicates that |
| | | | (srb1, | resources for |
| | | | srb2, | Split SRBs |
| | | | srb1&2, | are requested. |
| | | | . . .) | |
| PCell ID | O | | Global | |
| | | | NG-RAN | |
| | | | Cell | |
| | | | Identity | |
| | | | 9.2.2.27 | |
| Desired Activity | O | | 9.2.3.77 | |
| Notification Level | | | | |
| Available DRB IDs | C- | | DRB List | Indicates the list of |
| | ifSNterminated | | 9.2.1.29 | DRB IDs that the S- |
| | | | | NG-RAN node may |
| | | | | use for SN- |
| | | | | terminated bearers. |
| S-NG-RAN node | O | | Bit Rate | The S-NG-RAN |
| Maximum Integrity | | | 9.2.3.4 | node Maximum |
| Protected Data | | | | Integrity Protected |
| Rate Uplink | | | | Data Rate Uplink is |
| | | | | a portion of the UE's |
| | | | | Maximum Integrity |
| | | | | Protected Data Rate |
| | | | | in the Uplink, which |
| | | | | is enforced by the S- |
| | | | | NG-RAN node for |
| | | | | the UE's SN |
| | | | | terminated PDU |
| | | | | sessions. If the S- |
| | | | | NG-RAN node |
| | | | | Maximum Integrity |
| | | | | Protected Data Rate |
| | | | | Downlink IE is not |
| | | | | present, this IE |
| | | | | applies to both UL |
| | | | | and DL. |
| S-NG-RAN node | O | | Bit Rate | The S-NG-RAN |
| Maximum Integrity | | | 9.2.3.4 | node Maximum |
| Protected Data | | | | Integrity Protected |
| Rate Downlink | | | | Data Rate Downlink |
| | | | | is a portion of the |
| | | | | UE's Maximum |
| | | | | Integrity Protected |
| | | | | Data Rate in the |
| | | | | Downlink, which is |
| | | | | enforced by the S- |
| | | | | NG-RAN node for |
| | | | | the UE's SN |
| | | | | terminated PDU |
| | | | | sessions. |
| Location Information | O | | ENUMERATED | Indicates that the |
| at S-NODE | | | (pscell, | user's Location |
| reporting | | | . . .) | Information at S- |
| | | | | NODE is to be |
| | | | | provided. |
| MR-DC Resource | O | | 9.2.2.33 | Information used to |
| Coordination | | | | coordinate resource |
| Information | | | | utilisation between |
| | | | | M-NG-RAN node |
| | | | | and S-NG-RAN |
| | | | | node. |
| Masked IMEISV | O | | 9.2.3.32 | |
| NE-DC TDM Pattern | O | | 9.2.2.38 | |
| SN Addition Trigger | O | | ENUMERATED | This IE indicates the |
| Indication | | | (SN | trigger for S-NG- |
| | | | change, | RAN node Addition |
| | | | inter-MNHO, | Preparation |
| | | | intra-MNHO, | procedure |
| | | | . . .) | |
| Trace Activation | O | | 9.2.3.55 | |
| Requested Fast MCG | O | | ENUMERATED | Indicates that the |
| recovery via SRB3 | | | (true, | resources for fast |
| | | | . . .) | MCG recovery via |
| | | | | SRB3 are requested. |
| UE Radio Capability ID | O | | 9.2.3.138 | |
| Maximum Number of | O | | INTEGER | Indicates the |
| CPA configurations | | | (1 . . . 16) | maximum number of |
| | | | | PSCells which can |
| | | | | be configured for the |
| | | | | UE. |

| Range bound | Explanation |
|---|---|
| maxnoofPDUSessions | Maximum no. of PDU sessions. |
| | Value is 256 |

| Condition | Explanation |
|---|---|
| ifSNterminated | This IE shall be present if there is at least one |
| | PDU Session Resource Setup Info - SN |
| | terminated in the PDU Session Resources To Be |
| | Added List IE. |

In a step 2 depicted in FIG. 4, the node operating as T-SN candidate 56 sends to the MN 54 an S-NODE ADDITION REQUEST ACKNOWLEDGE message, including an RRC Reconfiguration message (e.g. RRCReconfiguration* created/generated by that T-SN candidate) associated to at least one Secondary Cell Group, wherein the SpCell and SCells of the SCG are associated to the T-SN candidate 56. That RRC Reconfiguration (RRCReconfiguration**) can be, e.g., included in an RRC container like the CG-Config.

In a particular embodiment, where the message received by the T-SN candidate 56 in step 1 includes a maximum number of PSCells, the T-SN candidate 56 will include at least one PSCell configuration, without exceeding the value of the maximum number of PSCells indicated by the MN 54.

In a particular embodiment where the message received by the T-SN candidate 56 in step 1 includes the number of requested PSCells, the T-SN candidate 56 will try fulfil the request by including the exact number of requested PSCell configurations. Depending on the received information in step 1 (e.g. measurement, PCell ID), the T-SN candidate 56 may include more PSCell configurations than requested.

In another particular embodiment, the maximum number of PSCells and the number of requested PSCells can be used in the same request.

The S-NODE ADDITION REQUEST ACKNOWLEDGE is given as an example. The message between the T-SN 56 and the MN 54 can also be:
A new message such as a Conditional SN Addition Ack

In a step 3 depicted in FIG. 4, and upon reception of the S-NODE ADDITION REQUEST ACKNOWLEDGE message, the MN 54 determines the PSCell configurations to be kept, taking into account the already configured candidate PSCells, the number of candidate PSCells received from other T-SNs and the maximum number of candidate PSCells which can be configured in the UE 52. If not all the candidate PSCell configurations provided by the T-SN 56 in the S-NODE ADDITION REQUEST ACKNOWLEDGE can be sent to the UE 52, the MN 54 sends an S-NODE MODIFICATION REQUEST message to the T-SN 56 to cancel one or multiple PSCell configurations.

In a step 4 depicted in FIG. 4, the T-SN 56 responds to the S-NODE MODIFICATION REQUEST with an S-NODE MODIFICATION REQUEST ACKNOWLEDGE message, acknowledging that the resources associated to the PSCell configurations signalled by the are cancelled.

In a step 5 depicted in FIG. 4, the MN 54 generates a new RRC Reconfiguration message (e.g. denoted RRCReconfiguration) to be provided to the UE, wherein that new RRC Reconfiguration message (RRCReconfiguration created/generated by the MN 54) contains at least a conditional reconfiguration (e.g. field conditionalReconfiguration and/or IE ConditionalReconfiguration for CPA), containing one or multiple PSCell configurations, given by the T-SN 56, and not cancelled by the MN 54.

In a step 6 depicted in FIG. 4, upon applying the message the UE 52 configures the conditional reconfiguration (i.e. start the monitoring of execution condition(s) and stores the RRC Reconfiguration for each target candidate PSCell, e.g., UE 52 stores per target candidate an RRCReconfiguration* that has an SCG configuration for the target candidate PSCell (e.g. nr-SCG=RRCReconfiguration** with a reconfiguration With Sync).

It may be noted that similar steps may be performed in case of an MN-initiated CPC, with the difference that the MN 54 requests to a T-SN candidate 56 to add CPC while the UE 52 is already configured with a Source SN (S-SN) and is operating in MR-DC.

### MN Compiles the Number of Candidate Target Cells

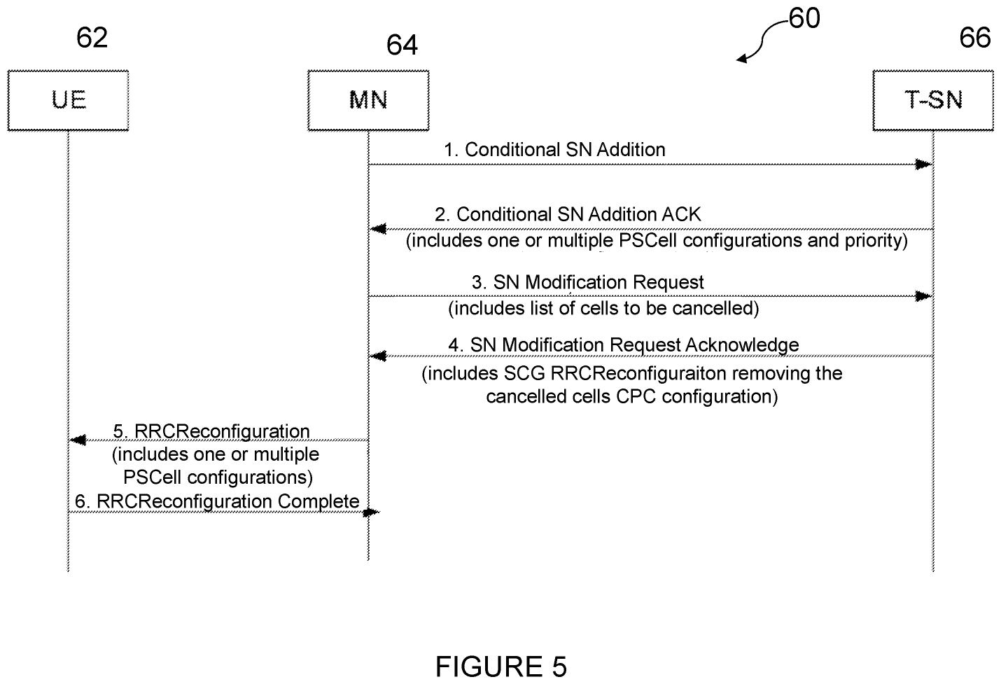

FIG. 5 illustrates another signaling diagram 60 for a conditional PSCell Addition, according to certain other embodiments. Many of the steps shown in FIG. 5 are similar to those described above with regard to FIG. 4. However, the key difference between FIG. 5 and FIG. 4 is that in the method illustrated in FIG. 5, there may be no limit on the number of target cells indicated from the MN 64 to the SN 66. Instead, the MN 64 makes a decision of which target cells to choose, possibly based on information provided by the SN 66 such as, for example, priority.

As depicted in FIG. 5, in a step 1, the node operating as a MN 64 for a UE 62 operating in MR-DC sends to the T-SN 66 an S-NODE ADDITION REQUEST message. Alternatively, the MN 64 may send the T-SN 66 a new message such as a CONDITIONAL S-NODE ADDITION, requesting configurations for candidate target cells for conditional CPAC. The request may contain additional information for the T-SN 66 such as, for example, measurements received from the UE, PCell ID, etc.

In a step 2 depicted in FIG. 5, the node operating as T-SN candidate 66 sends to the MN 64 an S-NODE ADDITION REQUEST ACKNOWLEDGE message. Alternatively, the T-SN candidate 66 may send, to the MN 64, another message such as CONDITIONAL S-NODE ADDITION REQUEST ACKNOWLEDGE, including an RRC Reconfiguration message (e.g. RRCReconfiguration** created/generated by that T-SN candidate 66) associated to at least one Secondary Cell Group, wherein the SpCell and SCells of the SCG are associated to the T-SN candidate 66. That RRC Reconfiguration (RRCReconfiguration**) can be, for example, included in an RRC container like the CG-Config.

In a particular embodiment, where multiple candidate target cells were configured by the T-SN 66, the request acknowledge message may contain a list of candidate target cells. In one particular embodiment, the cells in the request acknowledge message are listed in priority order by the T-SN 66. In another particular embodiment, the priority of each candidate target cell is explicitly indicated in the request acknowledge message, as described in more detail below.

### S-Node Addition Request Acknowledge

According to certain embodiments, a S-Node Addition Request Acknowledgement message is sent by the S-NG-RAN node to confirm the M-NG-RAN node about the S-NG-RAN node addition preparation. Thus, the direction of the message is from the S-NG-RAN node to the M-NG-RAN node.

| | | | IE type and | Semantics |
|---|---|---|---|---|
| IE/Group Name | Presence | Range | reference | description |
| Message Type | M | | 9.2.3.1 | |
| M-NG-RAN node UE | M | | NG-RAN | Allocated at the |
| XnAP ID | | | node UE | M-NG-RAN |
| | | | XnAP ID | node |
| | | | 9.2.3.16 | |
| S-NG-RAN node UE | M | | NG-RAN | Allocated at the |
| XnAP ID | | | node UE | S-NG-RAN |
| | | | XnAP ID | node |
| | | | 9.2.3.16 | |
| PDU Session | | 1 | | |
| Resources Admitted | | | | |
| To Be Added List | | | | |
| >PDU Session | | 1 . . . | | NOTE: If |
| Resources Admitted | | <maxnoofPDUSessions> | | neither the |
| To Be Added Item | | | | PDU Session |
| | | | | Resource Setup |
| | | | | Response Info - |
| | | | | SN terminated |
| | | | | IE |
| | | | | nor the |
| | | | | PDU Session |
| | | | | Resource Setup |
| | | | | Response Info - |
| | | | | MN terminated |
| | | | | IE |
| | | | | is present in a |
| | | | | PDU Session |
| | | | | Resources |
| | | | | Admitted to be |
| | | | | Added Item IE, |
| | | | | abnormal |
| | | | | conditions as |
| | | | | specified in |
| | | | | clause 8.3.1.4 |
| | | | | apply. |
| >>PDU Session ID | M | | 9.2.3.18 | |
| >>PDU Session | O | | 9.2.1.6 | |
| Resource Setup | | | | |
| Response Info - SN | | | | |
| terminated | | | | |
| >>PDU Session | O | | 9.2.1.8 | |
| Resource Setup | | | | |
| Response Info - MN | | | | |
| terminated | | | | |
| PDU Session | O | | | |
| Resources Not | | | | |
| Admitted List | | | | |
| >PDU Session | O | | PDU | |
| Resources Not | | | Session | |
| Admitted List - SN | | | Resources | |
| terminated | | | Not | |
| | | | Admitted | |
| | | | List | |
| | | | 9.2.1.3 | |
| >PDU Session | O | | PDU | |
| Resources Not | | | Session | |
| Admitted List - MN | | | Resources | |
| terminated | | | Not | |
| | | | Admitted | |
| | | | List | |
| | | | 9.2.1.3 | |
| S-NG-RAN node to | M | | OCTET | Includes the |
| M-NG-RAN node | | | STRING | CG-Config |
| Container | | | | message as |
| | | | | defined in |
| | | | | subclause 11.2.2 |
| | | | | of TS 38.331 |
| | | | | [10]. |
| Admitted Split SRBs | O | | ENUMERATED | Indicates |
| | | | (srb1, | admitted SRBs |
| | | | srb2, | |
| | | | srb1&2, | |
| | | | . . .) | |
| RRC Config Indication | O | | 9.2.3.72 | |
| Criticality Diagnostics | O | | 9.2.3.3 | |
| Location | O | | Target Cell | Contains |
| Information | | | Global ID | information |
| at S-NODE | | | 9.2.3.25 | to support |
| | | | | localisation |
| | | | | of the UE |
| MR-DC Resource | O | | 9.2.2.33 | Information |
| Coordination | | | | used to |
| Information | | | | coordinate |
| | | | | resource |
| | | | | utilisation |
| | | | | between M-NG- |
| | | | | RAN node and |
| | | | | S-NG-RAN |
| | | | | node. |
| Available fast | O | | ENUMERATED | Indicates the fast |
| MCG recovery | | | (true, | MCG recovery |
| via SRB3 | | | . . .) | via SRB3 is |
| | | | | enabled. |
| Conditional | O | | | |
| Reconfiguration | | | | |
| Acknowledge | | | | |
| >Requested | M | | Target Cell | Target cell |
| Target | | | Global ID | indicated in the |
| Cell ID | | | 9.2.3.25 | corresponding |
| | | | | S-NODE |
| | | | | ADDITION |
| | | | | REQUEST |
| | | | | message |
| >Priority of | O | | INTEGER | |
| target cell | | | (0 . . . 16) | |

| Range bound | Explanation |
|---|---|
| maxnoofPDUSessions | Maximum no. of PDU sessions. |
| | Value is 256 |

In a step 3 depicted in FIG. 5, upon reception of the S-NODE ADDITION REQUEST ACKNOWLEDGE message, the MN 64 determines the PSCell configurations to be kept, taking into account the already configured candidate PSCells, the number of candidate PSCells received from other T-SNs 66 and the maximum number of candidate PSCells that can be configured in the UE 62.

The MN 64 may determine which target cells to be configured based on, for example, priority indicated by the T-SN 66 (implicitly or explicitly) and/or based on measurements received from the UE 62.

If not all the candidate PSCell configurations provided by the T-SN 66 in the S-NODE ADDITION REQUEST ACKNOWLEDGE can be sent to the UE 62, the MN 64 sends an S-NODE MODIFICATION REQUEST message to the T-SN 66 to cancel one or multiple PSCell configurations.

In a step 5 depicted in FIG. 5, the MN 64 generates a new RRC Reconfiguration message to be provided to the UE 62. That new RRC Reconfiguration message (RRCReconfiguration created/generated by the MN 64) contains at least a conditional reconfiguration (e.g. field conditionalReconfiguration and/or IE ConditionalReconfiguration for CPA), containing one or multiple PSCell configurations, given by the T-SN 66, and not cancelled by the MN 64.

In a step 6 depicted in FIG. 5, upon applying the message, the UE 62 configures the conditional reconfiguration (i.e. starts monitoring of execution condition(s) and stores the RRC Reconfiguration for each target candidate PSCell. Thus, for each target candidate, the UE stores an RRCReconfiguration* that has an SCG configuration for the target candidate PSCell (e.g. nr-SCG=RRCReconfiguration** with a reconfiguration With Sync).

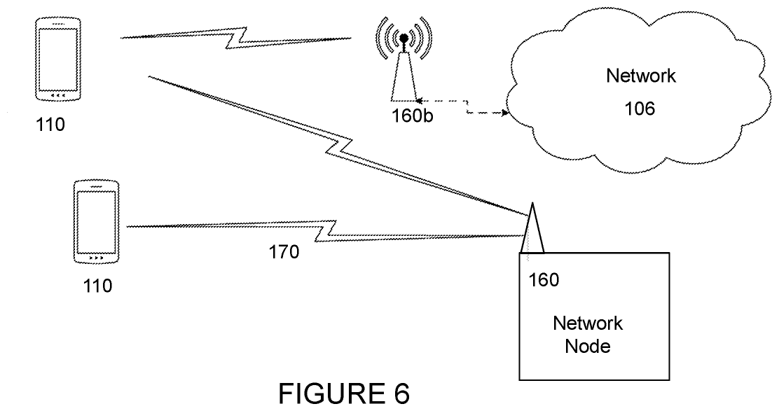

FIG. 6 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 106, network nodes 160 and 160b, and wireless devices 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

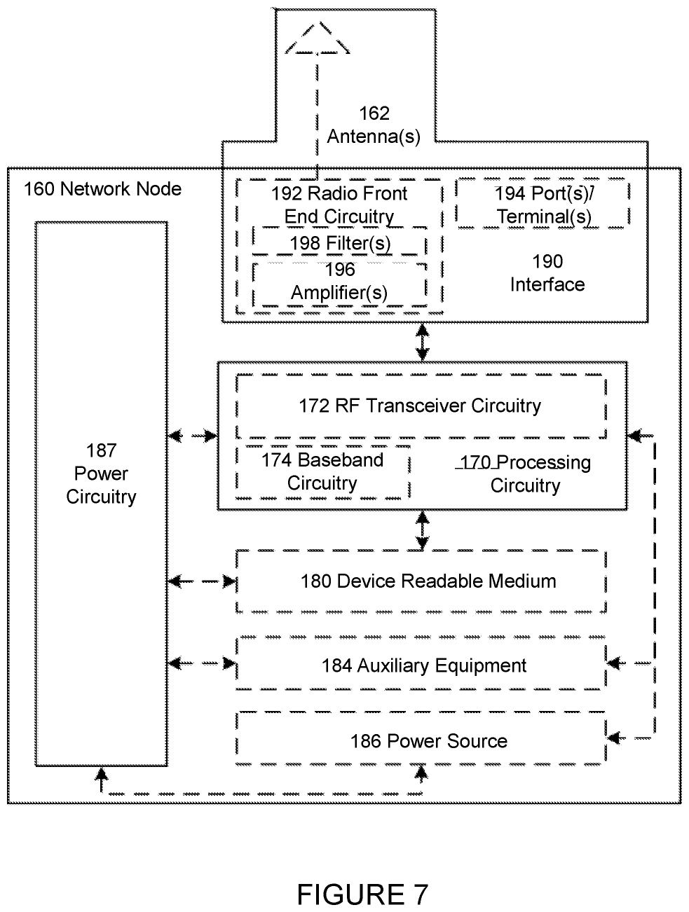

FIG. 7 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 7, network node 160 includes processing circuitry 170, device readable medium 180, interface 190, auxiliary equipment 184, power source 186, power circuitry 187, and antenna 162. Although network node 160 illustrated in the example wireless network of FIG. 7 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 7 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

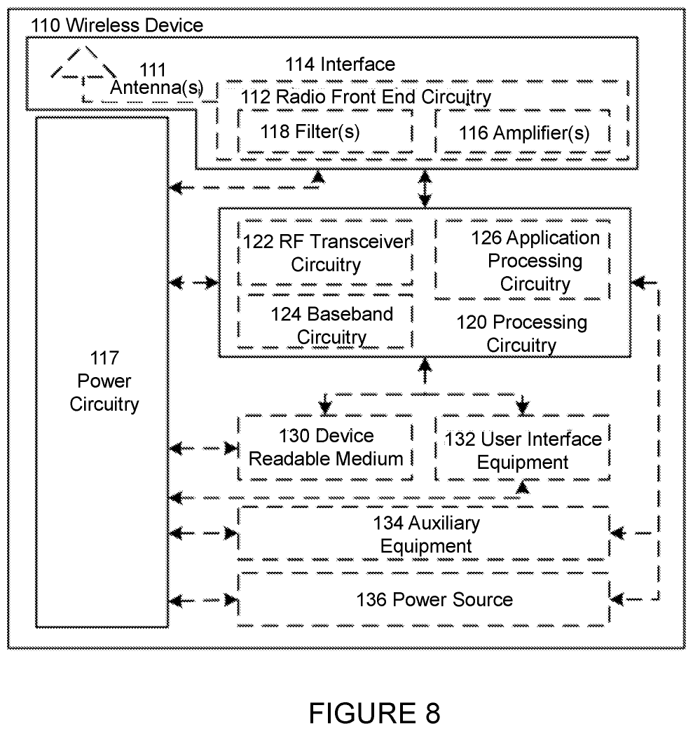

FIG. 8 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

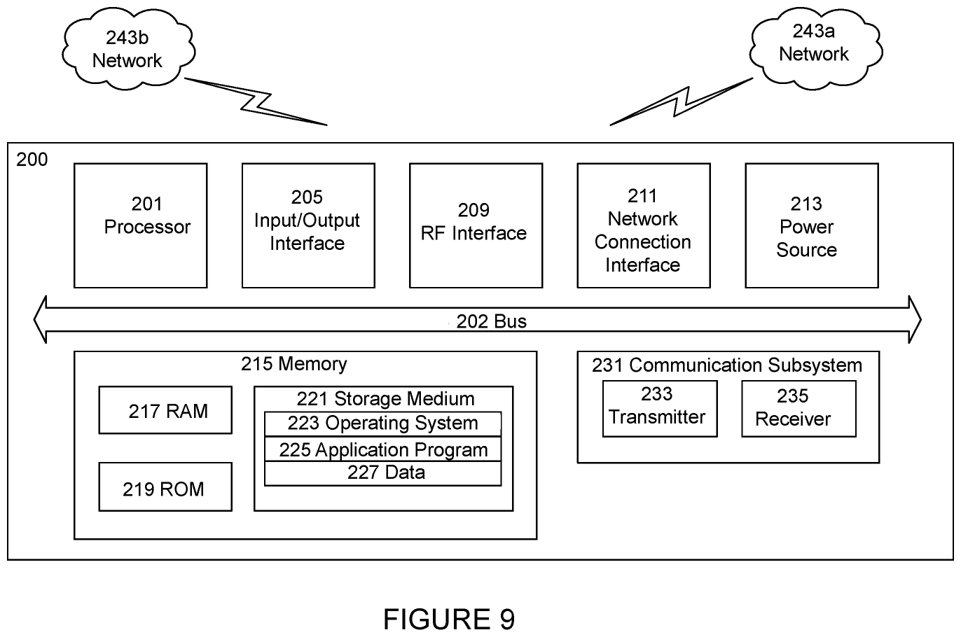

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3rd Generation Partnership Project (3GPP), including a NB-IoT UE, a machine type communication (MTC) UE, and/or an enhanced MTC (eMTC) UE. UE 200, as illustrated in FIG. 7, is one example of a wireless device configured for communication in accordance with one or more communication standards promulgated by the 3rd Generation Partnership Project (3GPP), such as 3GPP's GSM, UMTS, LTE, and/or 5G standards. As mentioned previously, the term wireless device and UE may be used interchangeable. Accordingly, although FIG. 9 is a UE, the components discussed herein are equally applicable to a wireless device, and vice-versa.

In FIG. 9, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 9, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

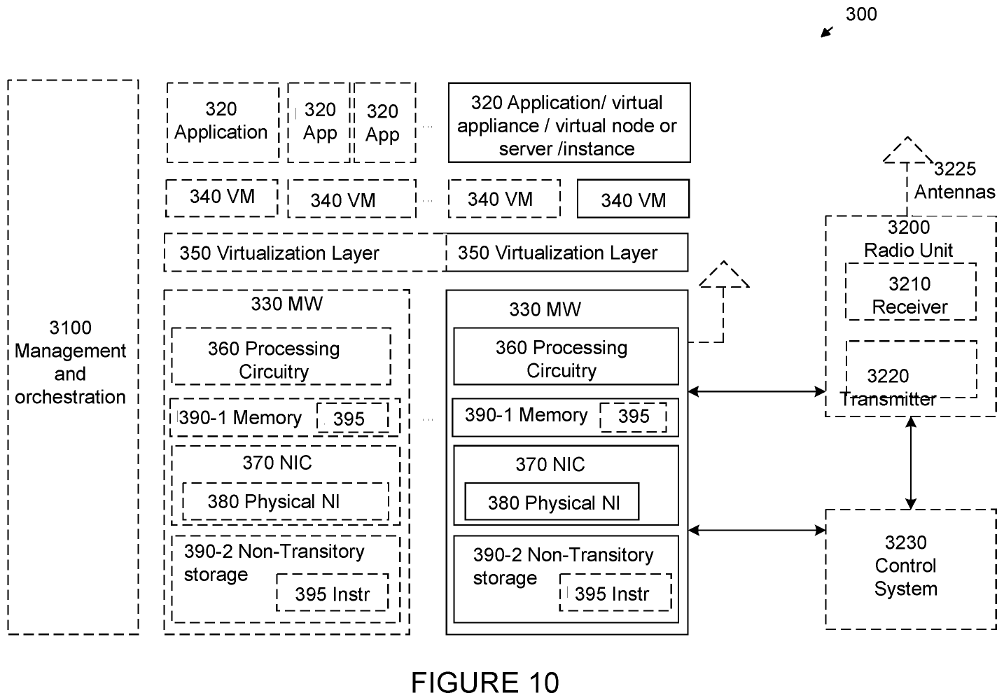

FIG. 10 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 10, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV. Virtual Network Function (VNF) is responsible for handling specific network functions that run in one or more virtual machines 340 on top of hardware networking infrastructure 330 and corresponds to application 320 in FIG. 10.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

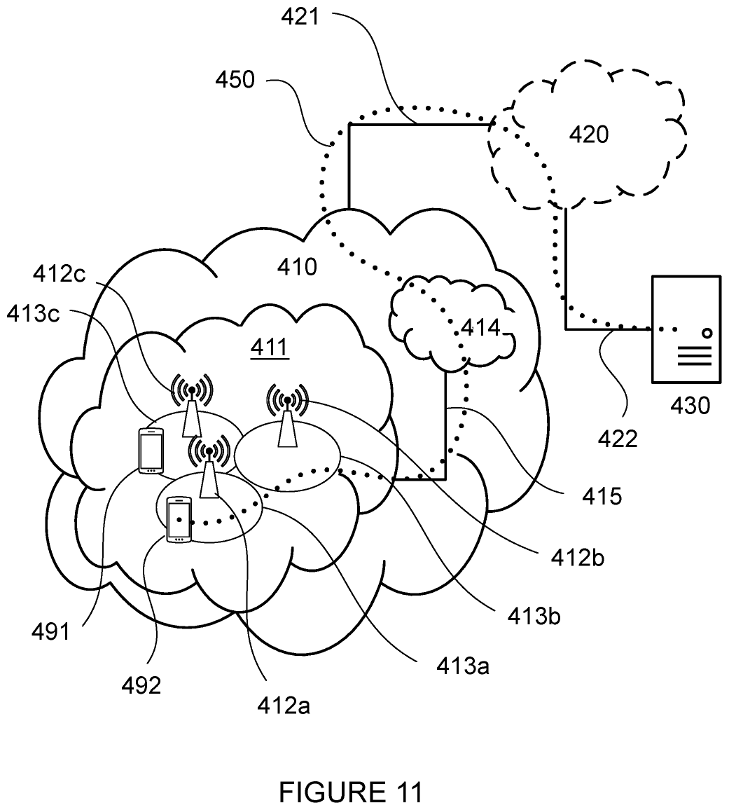

FIG. 11 illustrates a telecommunication network connected via an intermediate network to a host computer in accordance with some embodiments.

With reference to FIG. 11, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 11 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

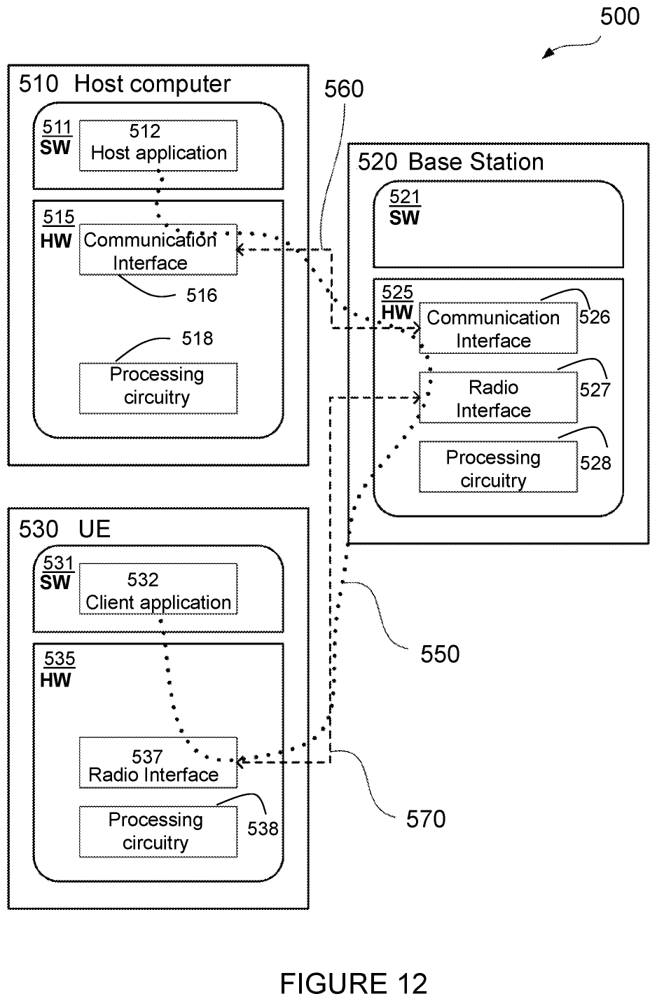

FIG. 12 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 12. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 12) served by base station 520. Communication interface 526 may be configured to facilitate connection 560 to host computer 510. Connection 560 may be direct or it may pass through a core network (not shown in FIG. 12) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 12 may be similar or identical to host computer 430, one of base stations 412a, 412b, 412c and one of UEs 491, 492 of FIG. 11, respectively. This is to say, the inner workings of these entities may be as shown in FIG. 12 and independently, the surrounding network topology may be that of FIG. 11.

In FIG. 12, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

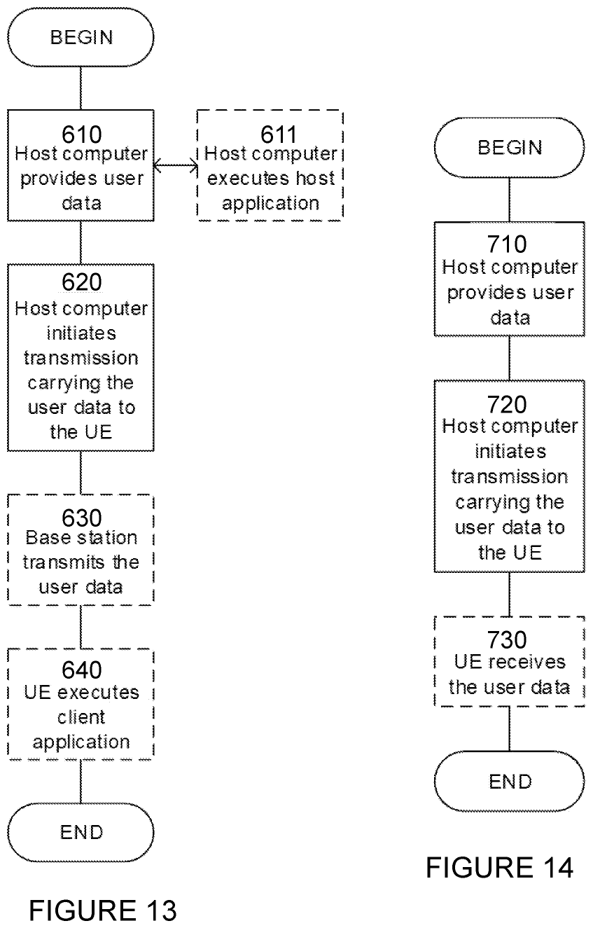

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

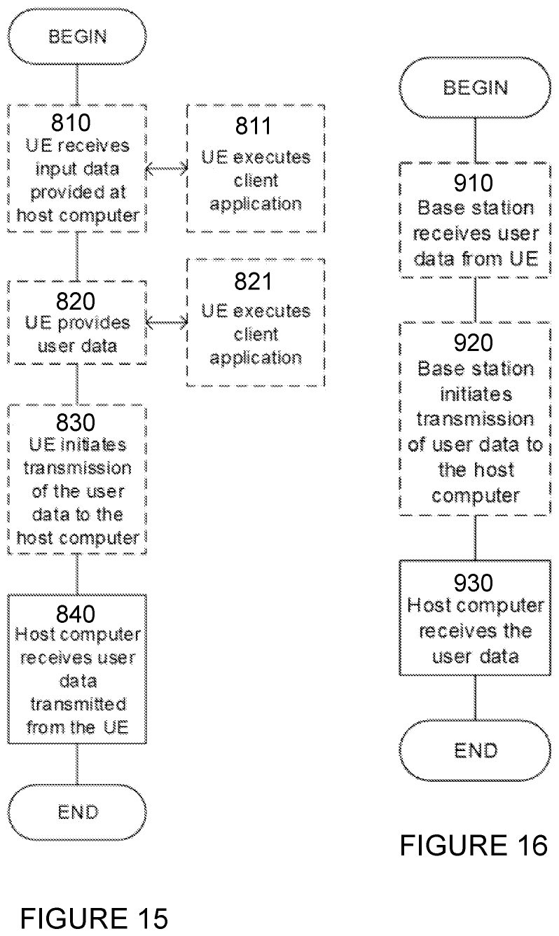

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

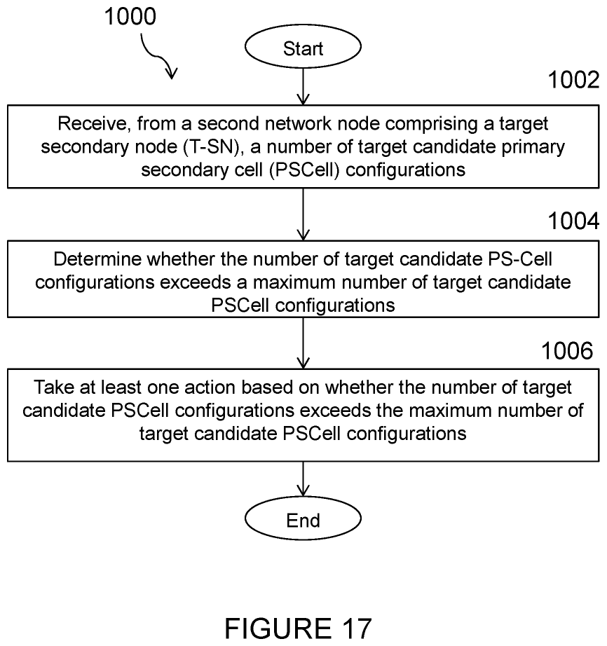

FIG. 17 depicts a method 1000 by a first network node 160 operating as a MN 54, 64, according to certain embodiments. At step 1002, the first network node 160 receives, from a second network node 160 comprising a T-SN 56, 66, a number of target candidate PSCell configurations. At step 1004, the first network node 160 determines whether the number of target candidate PSCell configurations exceeds a maximum number of target candidate PSCell configurations. At step 1006, the first network node 160 takes at least one action based on whether the number of target candidate PSCell configurations exceeds the maximum number of target candidate PSCell configurations.

In various particular embodiments, the method may include any of the steps and features disclosed below in the Group A Example Embodiments.

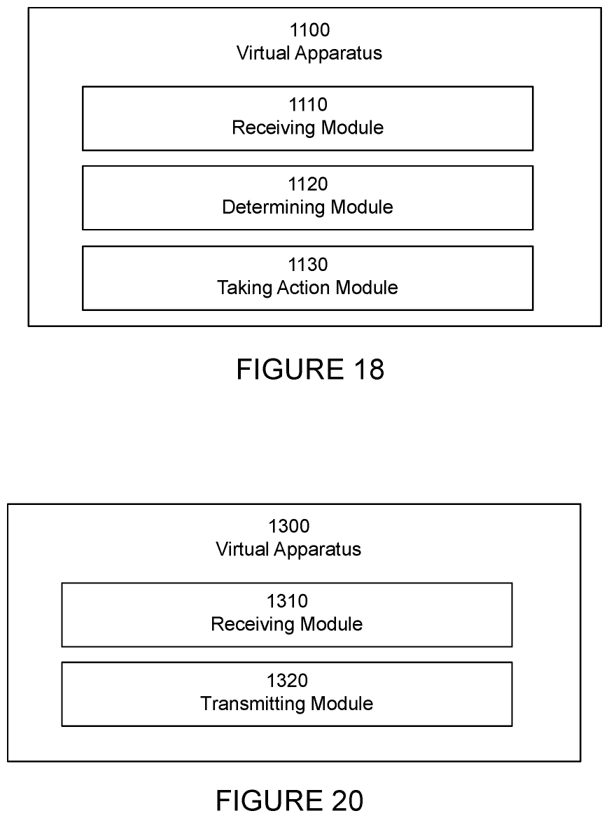

FIG. 18 illustrates a schematic block diagram of a virtual apparatus 1100 in a wireless network (for example, the wireless network shown in FIG. 6). The apparatus may be implemented in a wireless device or network node (e.g., wireless device 110 or network node 160 shown in FIG. 6). Apparatus 1100 is operable to carry out the example method described with reference to FIG. 17 and possibly any other processes or methods disclosed herein. It is also to be understood that the method of FIG. 17 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1110, determining module 1120, taking action module 1130, and any other suitable units of apparatus 1100 to perform corresponding functions according one or more embodiments of the present disclosure.

According to certain embodiments, receiving module 1110 may perform certain of the receiving functions of the apparatus 1100. For example, receiving module 1110 may receive, from a second network node comprising a target secondary node (SN), a number of target candidate primary secondary cell (PSCell) configurations.

According to certain embodiments, determining module 1120 may perform certain of the determining functions of the apparatus 1100. For example, determining module 1120 may determine whether the number of target candidate PSCell configurations exceeds a maximum number of target candidate PSCell configurations.

According to certain embodiments, taking action module 1130 may perform certain of the taking action functions of the apparatus 1100. For example, taking action module 1120 may take at least one action based on whether the number of target candidate PSCell configurations exceeds the maximum number of target candidate PSCell configurations.

In particular embodiments, virtual apparatus 1100 may additionally include modules for performing any of the steps and features disclosed below in the Group A Example Embodiments.

As used herein, the term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

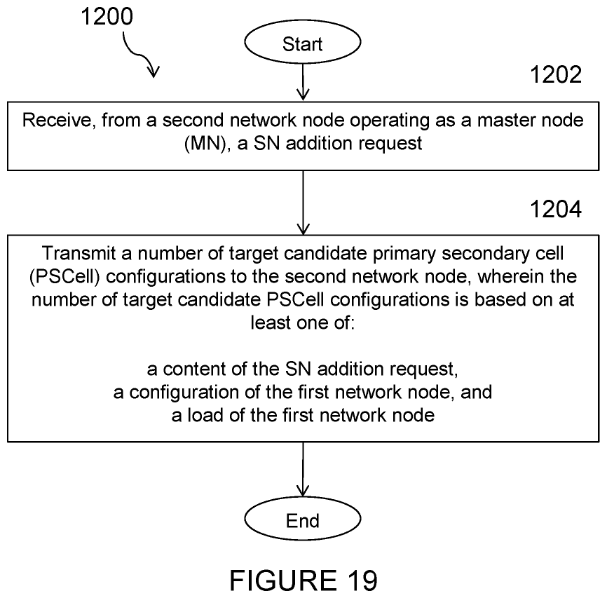

FIG. 19 depicts a method 1200 by a first network node 160 operating as a T-SN 56, 66, according to certain embodiments. At step 1202, the first network node 160 receives, from a second network node 160 operating as a MN 54, 64, a SN addition request. At step 1204, the first network node 160 transmits a number of target candidate PSCell configurations to the second network node 160. The number of target candidate PSCell configurations is based on at least one of: a content of the SN addition request, a configuration of the first network node 160, and a load of the first network node 160.

In various particular embodiments, the method may include any of the steps and features disclosed below in the Group B Example Embodiments.

FIG. 20 illustrates a schematic block diagram of a virtual apparatus 1300 in a wireless network (for example, the wireless network shown in FIG. 6). The apparatus may be implemented in a wireless device or network node (e.g., wireless device 110 or network node 160 shown in FIG. 6). Apparatus 1300 is operable to carry out the example method described with reference to FIG. 19 and possibly any other processes or methods disclosed herein. It is also to be understood that the method of FIG. 19 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1310, transmitting module 1320, and any other suitable units of apparatus 1300 to perform corresponding functions according one or more embodiments of the present disclosure.

According to certain embodiments, receiving module 1310 may perform certain of the receiving functions of the apparatus 1300. For example, receiving module 1310 may receive, from a second network node operating as a MN, a SN addition request.

According to certain embodiments, transmitting module 1320 may perform certain of the transmitting functions of the apparatus 1300. For example, transmitting module 1320 may transmit a number of target candidate PSCell configurations to the second network node. The number of target candidate PSCell configurations is based on at least one of: a content of the SN addition request, a configuration of the first network node, and a load of the first network node.

In particular embodiments, virtual apparatus 1300 may additionally include modules for performing any of the steps and features disclosed below in the Group B Example Embodiments.

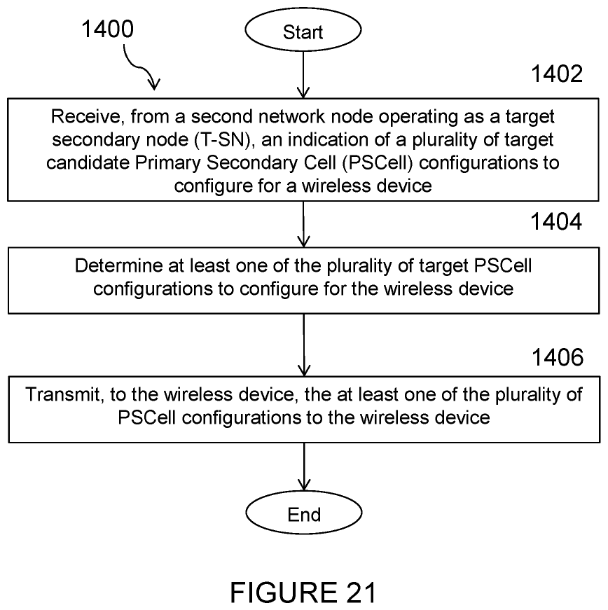

FIG. 21 depicts a method 1400 by a first network node 160 operating as a MN 54, 64, according to certain embodiments. At step 1402, the first network node 160 includes receiving, from a second network node 160 comprising a T-SN 56, 66, an indication of a plurality of target candidate PSCell configurations to configure for a wireless device 110, 52. At step 1404, the first network node 160 determines at least one of the plurality of target PSCell configurations to configure for the wireless device 110, 52. At step 1406, the first network node 160 transmits, to the wireless device 110, 52, 62, the at least one of the plurality of PSCell configurations to the wireless device 110, 52, 62.

In various particular embodiments, the method may include any of the steps and features disclosed below in the Group C Example Embodiments.

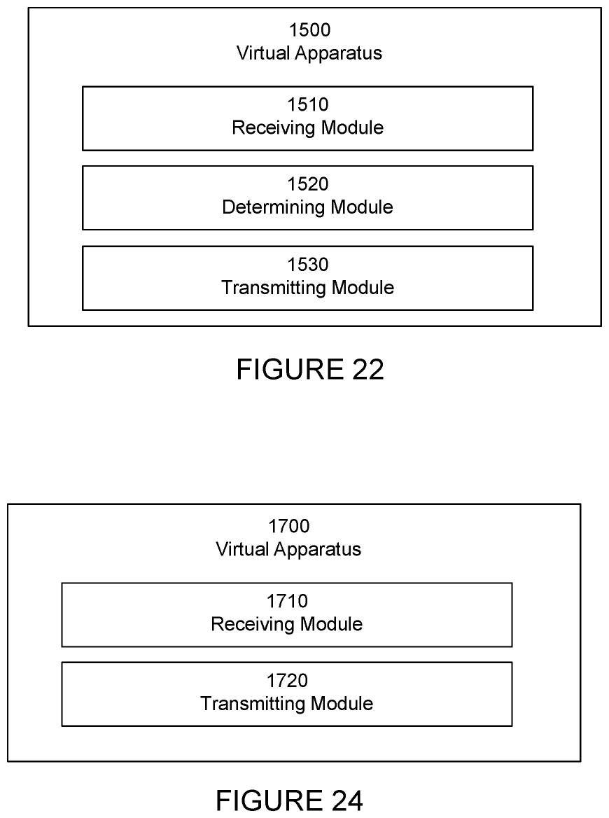

FIG. 22 illustrates a schematic block diagram of a virtual apparatus 1500 in a wireless network (for example, the wireless network shown in FIG. 6). The apparatus may be implemented in a wireless device or network node (e.g., wireless device 110 or network node 160 shown in FIG. 6). Apparatus 1500 is operable to carry out the example method described with reference to FIG. 21 and possibly any other processes or methods disclosed herein. It is also to be understood that the method of FIG. 21 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1510, determining module 1520, transmitting module 1530, and any other suitable units of apparatus 1500 to perform corresponding functions according one or more embodiments of the present disclosure.

According to certain embodiments, receiving module 1510 may perform certain of the receiving functions of the apparatus 1500. For example, receiving module 1510 may receive, from a second network node comprising a T-SN, an indication of a plurality of target candidate PSCell configurations to configure for a wireless device.

According to certain embodiments, determining module 1520 may perform certain of the determining functions of the apparatus 1500. For example, determining module 1520 may determine at least one of the plurality of target PSCell configurations to configure for the wireless device.

According to certain embodiments, transmitting module 1530 may perform certain of the transmitting functions of the apparatus 1500. For example, transmitting module 1530 may transmit, to the wireless device, the at least one of the plurality of PSCell configurations to the wireless device.

In particular embodiments, virtual apparatus 1500 may additionally include modules for performing any of the steps and features disclosed below in the Group C Example Embodiments.

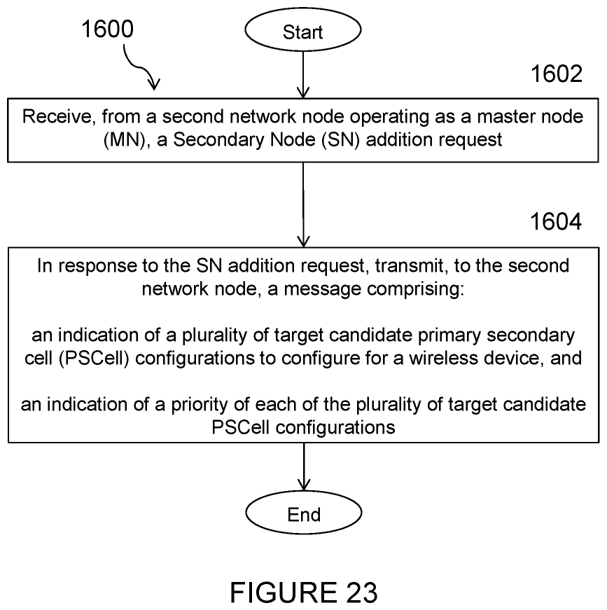

FIG. 23 depicts a method 1600 by a first network node 160 operating as a T-SN 56, 66, according to certain embodiments. At step 1602, the network node 160 receives, from a second network node 160 operating as a MN 54, 64, a SN addition request. At step 1604, in response to the SN addition request, the first network node 160 transmits, to the second network node 160, a message. The message includes an indication of a plurality of target candidate PSCell configurations to configure for a wireless device 110, 52, 62 and an indication a priority of each of the plurality of target candidate PSCell configurations.

In various particular embodiments, the method may include any of the steps and features disclosed below in the Group D Example Embodiments.

FIG. 24 illustrates a schematic block diagram of a virtual apparatus 1700 in a wireless network (for example, the wireless network shown in FIG. 6). The apparatus may be implemented in a wireless device or network node (e.g., wireless device 110 or network node 160 shown in FIG. 6). Apparatus 1700 is operable to carry out the example method described with reference to FIG. 23 and possibly any other processes or methods disclosed herein. It is also to be understood that the method of FIG. 23 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1710, transmitting module 1720, and any other suitable units of apparatus 1700 to perform corresponding functions according one or more embodiments of the present disclosure.

According to certain embodiments, receiving module 1710 may perform certain of the receiving functions of the apparatus 1700. For example, receiving module 1710 may receive, from a second network node operating as a MN, a SN addition request.

According to certain embodiments, transmitting module 1720 may perform certain of the transmitting functions of the apparatus 1700. For example, in response to the SN addition request, transmitting module TO may transmit, to the second network node, a message. The message includes an indication of a plurality of target candidate PSCell configurations to configure for a wireless device and an indication a priority of each of the plurality of target candidate PSCell configurations.

In particular embodiments, virtual apparatus 1700 may additionally include modules for performing any of the steps and features disclosed below in the Group D Example Embodiments.

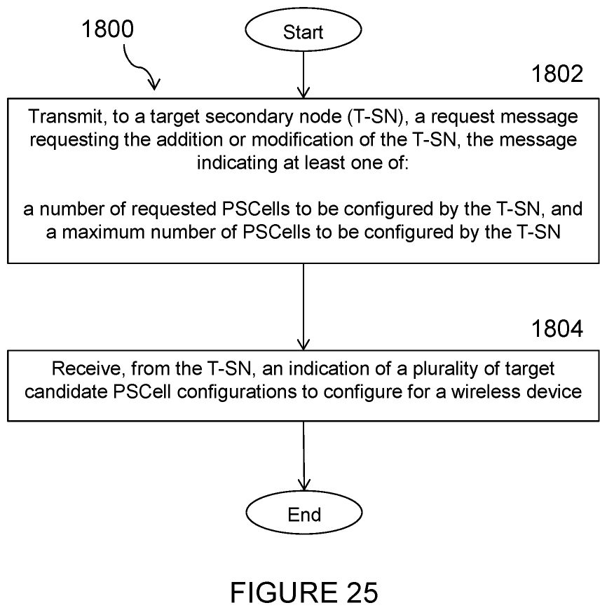

FIG. 25 illustrates another example method 1800 by a MN 54, 64, according to certain embodiments. The method begins at step 1802 when the MN 54, 64 transmits, to a T-SN 56, 66, a request message requesting the addition or modification of the T-SN 56, 66. The message indicates at least one of: a number of requested primary secondary cells, PSCells, to be configured by the T-SN 56, 66; and a maximum number of PSCells to be configured by the T-SN 56, 66. At step 1804, the MN 54, 64 receives, from the T-SN 56, 66, an indication of a plurality of target candidate PSCell configurations to configure for a wireless device 110, 52, 62.

In a particular embodiment, the plurality of target candidate PSCell configurations does not exceed the number of requested PSCells to be configured by the T-SN 56, 66 and/or the maximum number of PSCells to be configured by the T-SN 56, 66.

In a particular embodiment, the MN 54, 64 selects at least one of the plurality of target PSCell configurations for configuration for the wireless device 110, 52, 62.

In a further particular embodiment, when selecting the at least one of the plurality of target PSCell configuration, the MN 54, 64 determines a respective priority value for each of the plurality of target PSCell configurations and selects the at least one of the plurality of target PSCell configurations based on the respective priority values.

In a particular embodiment, the indication of the plurality of target candidate PSCell configurations comprises a prioritized listing of the plurality of target candidate PSCell configurations, and the MN 54, 64 selects the at least one of the plurality of target PSCell configurations based on the prioritized listing.

In a particular embodiment, the MN 54, 64 selects a number of target candidate PSCell configurations from the plurality of target candidate PSCell configurations, and the number of target candidate PSCell configurations does not exceed a maximum number of target candidate PSCell configurations.

In a particular embodiment, a number of the plurality of target candidate PSCell configurations exceeds the maximum number of target PSCell configurations, and the MN 54, 64 cancels at least one of the target candidate PSCell configurations.

In a further particular embodiment, the MN 54, 64 transmits, to the T-SN 56, 66, an indication of the at least one of the target candidate PSCell configurations that is cancelled.

In a further particular embodiment, the SN addition request comprises at least one measurement, and each measurement is associated with a cell.

In a particular embodiment, the message includes a conditional SN addition request comprising an indication of a MN-initiated conditional PSCell change or a SN change request from a source SN.

In particular embodiments, method 1800 may additionally or alternatively include any of the steps and features disclosed with regard to any of the example embodiments described herein.

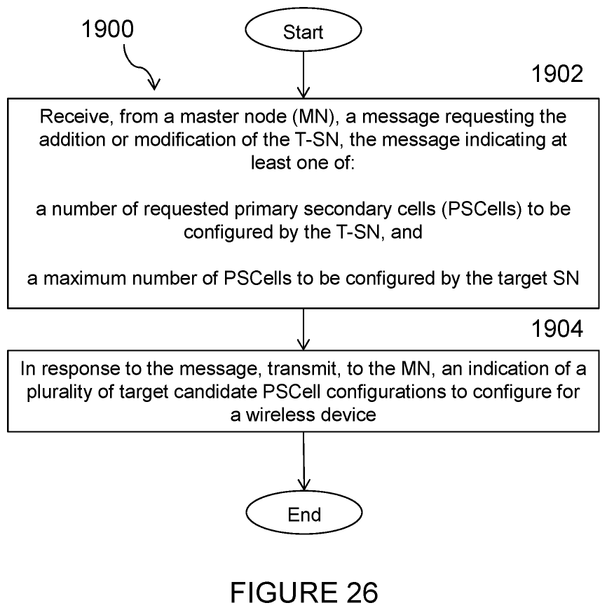

FIG. 26 illustrates another example method 1900 by a T-SN, according to certain embodiments. The method begins at step 1902 when the T-SN receives, from a master node, MN, a message requesting the addition or modification of the target secondary node. The message indicates at least one of: a number of requested PSCells to be configured by the T-SN; and a maximum number of PSCells to be configured by the T-SN. In response to the message, the T-SN transmits, to the MN, an indication of a plurality of target candidate PSCell configurations to configure for a wireless device, at step 1904.

In a particular embodiment, the plurality of target candidate PSCell configurations does not exceed the number of requested PSCells to be configured by the T-SN and/or the maximum number of PSCells to be configured by the T-SN.

In a particular embodiment, the indication of the plurality of target candidate PSCell configurations comprises at least one of: an indication a priority of each of the plurality of target candidate PSCell configurations, and a prioritized listing of the plurality of target candidate PSCell configurations.

In a particular embodiment, the T-SN receives from the MN a message cancelling at least one of the plurality of target candidate PSCell configurations.

In a further particular embodiment, the at least one of the target candidate PSCell configurations that is cancelled is associated with at least one lower priority value.

In a particular embodiment, the message comprises at least one measurement, and wherein each measurement is associated with a cell.

In a particular embodiment, the message comprises: a conditional SN addition request comprising an indication of a MN-initiated conditional PSCell change, or a SN change request from a source SN.

In particular embodiments, method 1900 may additionally or alternatively include any of the steps and features disclosed with regard to any of the example embodiments described herein.

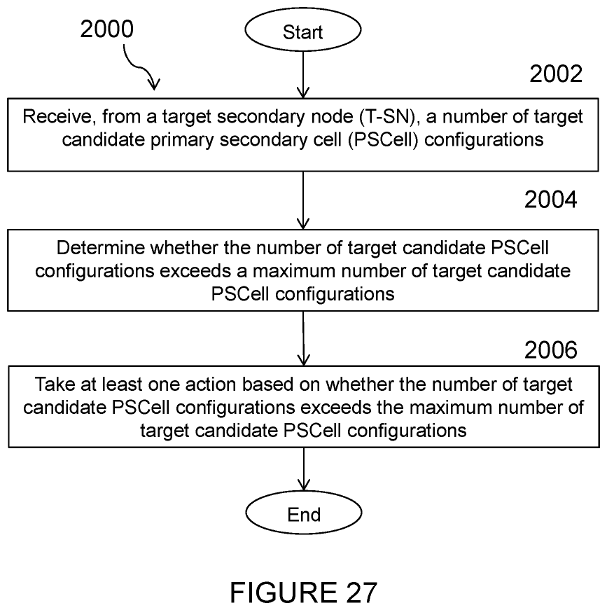

FIG. 27 illustrates another example method 2000 by a MN 54, 64, according to certain embodiments. The method begins at step 2002 when the MN 54, 64 receives, from a T-SN 56, 66, a number of target candidate PSCell configurations. At step 2004, the MN 54, 64 determines whether the number of target candidate PSCell configurations exceeds a maximum number of target candidate PSCell configurations. At step 2006, the MN 54, 64 takes at least one action based on whether the number of target candidate PSCell configurations exceeds the maximum number of target candidate PSCell configurations.

In a particular embodiment, the number of target candidate PSCell configurations exceeds the maximum number of target candidate PSCell configurations, and taking the at least one action includes cancelling at least one of the target candidate PSCell configurations and transmitting at least one remaining PSCell configuration that is not cancelled to a wireless device.

In another particular embodiment, the number of target candidate PSCell configurations does not exceed the maximum number of target candidate PSCell configurations, and taking the at least one action comprises transmitting the PSCell configurations to a wireless device.

In a particular embodiment, the MN transmits, to the T-SN, a SN addition request, and the number of target candidate PSCell configurations are received in response to the SN addition request.

In a further particular embodiment, the SN addition request comprises at least one of: a number of requested PSCells to be configured by the T-SN; and a maximum number of PSCells to be configured by the T-SN.

In a further particular embodiment, the SN addition request comprises at least one measurement, and each measurement is associated with a cell. A number of measurements included in the SN addition request indicate at least one of: a number of requested PSCells to be configured by the T-SN; and a maximum number of PSCells to be configured by the T-SN.

In a particular embodiment, the SN addition request includes an indication of a MN-initiated conditional PSCell change, or an indication of a source node-initiated PSCell change.

In particular embodiments, method 2000 may additionally or alternatively include any of the steps and features disclosed with regard to any of the example embodiments described herein.

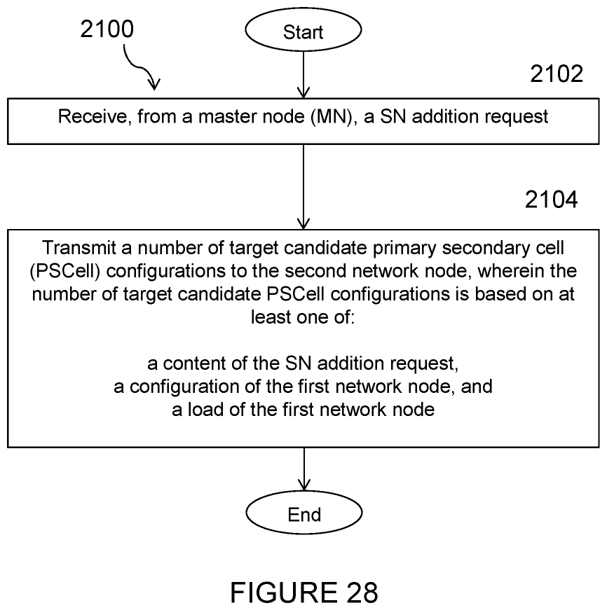

FIG. 28 illustrates another example method 2100 by a T-SN 56, 66, according to certain embodiments. The method begins at step 2102 when the T-SN 56, 66 receives, from a MN 54, 64, a SN addition request. At step 2104, the T-SN 56, 66 transmits a number of target candidate PSCell configurations to the MN 54, 64. The number of target candidate PSCell configurations is based on at least one of: a content of the SN addition request, a configuration of the T-SN 56, 66, and a load of the T-SN 56, 66.

In a particular embodiment, the SN addition request comprises at least one of: a number of requested PSCells to be configured by the MN; and a maximum number of PSCells to be configured by the MN.

In a particular embodiment, the SN addition request comprises at least one measurement, and each measurement is associated with a cell. The first network node determines the number of requested PSCells to be configured and/or the maximum number of PSCells to be configured based on a number of measurements included in the SN addition request.

In a particular embodiment, the SN addition request comprises: an indication of a MN-initiated conditional PSCell change, or an indication of a source node-initiated PSCell change.

In a particular embodiment, the T-SN receives, from the MN, a request cancelling at least one of the target candidate PSCell configurations.

In particular embodiments, method 2100 may additionally or alternatively include any of the steps and features disclosed with regard to any of the example embodiments described herein.

### Example Embodiments

### Group A Embodiments

Example A1. A method by a first network node operating as a master node (MN) comprises: receiving, from a second network node comprising a target secondary node (SN), a number of target candidate primary secondary cell (PSCell) configurations; determining whether the number of target candidate PSCell configurations exceeds a maximum number of target candidate PSCell configurations; and taking at least one action based on whether the number of target candidate PSCell configurations exceeds the maximum number of target candidate PSCell configurations.

Example A2. The method of Example Embodiment A1, wherein: the number of target candidate PSCell configurations exceeds the maximum number of target candidate PSCell configurations, and taking the at least one action comprises: cancelling at least one of the target candidate PSCell configurations and transmitting at least one remaining PSCell configuration that is not cancelled to a wireless device.

Example A3. The method of Example Embodiment A2, wherein: the number of target candidate PSCell configurations does not exceed the maximum number of target candidate PSCell configurations, and taking the at least one action comprises transmitting the PSCell configurations to a wireless device.

Example A4. The method of any one of Example Embodiments A1 to A3, further comprising: transmitting, to the second network node, a SN addition request, and wherein the number of target candidate PSCell configurations are received in response to the SN addition request.

Example A5. The method of Example Embodiment A4, wherein the SN addition request comprises at least one of: a number of requested PSCells to be configured by the second network node; and a maximum number of PSCells to be configured by the second network node.

Example A6. The method of Example Embodiment A5, wherein the number of requested PSCells and/or the maximum number of PSCells to be configured comprise at least one integer.

Example A7. The method of Example Embodiment A4, wherein the SN addition request comprises at least one measurement, and wherein each measurement is associated with a cell, wherein a number of measurements included in the SN addition request indicates at least one of: a number of requested PSCells to be configured by the second network node; and a maximum number of PSCells to be configured by the second network node.

Example A8. The method of any one of Example Embodiments A4 to A7, wherein the SN addition request comprises a conditional SN addition request comprising an indication of a conditional PSCell change.

Example A9. The method of Example Embodiment A8, wherein the conditional PSCell change comprises a MN-initiated conditional PSCell change (CPC).

Example A10. The method of Example Embodiment A8, further comprising receiving a SN change request from a third network node operating as a source SN, and wherein the conditional PSCell change request is transmitted to the second network node in response to receiving the SN change request.

Example A11. The method of any one of Example Embodiments A1 to A10, wherein the first network node comprises a gNodeB.

Example A12. A network node comprising processing circuitry configured to perform any of the methods of Example Embodiments A1 to A11.

Example A13. A computer program comprising instructions which when executed on a computer perform any of the methods of Example Embodiments A1 to A11.

Example A14. A computer program product comprising computer program, the computer program comprising instructions which when executed on a computer perform any of the methods of Example Embodiments A1 to A11.

Example A15. A non-transitory computer readable medium storing instructions which when executed by a computer perform any of the methods of Example Embodiments A1 to A11.

### Group B Embodiments

Example B1. A method by a first network node operating as a target secondary node (SN) comprises: receiving, from a second network node operating as a master node (MN), a SN addition request; transmitting a number of target candidate primary secondary cell (PSCell) configurations to the second network node, wherein the number of target candidate PSCell configurations is based on at least one of: a content of the SN addition request, a configuration of the first network node, and a load of the first network node.

Example B2. The method of Example Embodiment B1, wherein the SN addition request comprises at least one of: a number of requested PSCells to be configured by the second network node; and a maximum number of PSCells to be configured by the second network node.

Example B3. The method of Example Embodiment B2, wherein the number of requested PSCells and/or the maximum number of PSCells to be configured comprise at least one integer.

Example B4. The method of Example Embodiment B2, wherein the SN addition request comprises at least one measurement, each measurement being associated with a cell, and wherein the first network node determines the number of requested PSCells to be configured and/or the maximum number of PSCells to be configured based on a number of measurements included in the SN addition request.

Example B5. The method of any one of Example Embodiments B1 to B4, wherein the SN addition request comprises a conditional SN addition request, the conditional SN addition request comprising an indication of a conditional PSCell change.

Example B6. The method of Example Embodiment B5, wherein the conditional PSCell change comprises a MN-initiated conditional PSCell change (CPC).

Example B7. The method of Example Embodiment B5, wherein the conditional PSCell change request comprises a source node-initiated PSCell change.

Example B8. The method of any one of Example Embodiments B1 to B7, further comprising receiving, from the second network node, a request cancelling at least one of the target candidate primary secondary cell (PSCell) configurations.

Example B9. The method of any one of Example Embodiments B1 to B8, wherein the first network node comprises a gNodeB.

Example B10. A network node comprising processing circuitry configured to perform any of the methods of Example Embodiments B1 to B9.

Example B11. A computer program comprising instructions which when executed on a computer perform any of the methods of Example Embodiments B1 to B9.

Example B12. A computer program product comprising computer program, the computer program comprising instructions which when executed on a computer perform any of the methods of Example Embodiments B1 to B9.

Example B13. A non-transitory computer readable medium storing instructions which when executed by a computer perform any of the methods of Example Embodiments B1 to B9.

### Group C Embodiments

Example C1. A method by a first network node operating as a master node (MN) comprises: receiving, from a second network node comprising a target secondary node (SN), an indication of a plurality of target candidate primary secondary cell (PSCell) configurations to configure for a wireless device; and determining at least one of the plurality of target PSCell configurations to configure for the wireless device; and transmitting, to the wireless device, the at least one of the plurality of PSCell configurations to the wireless device.

Example C2. The method of Example Embodiment C1, wherein determining the at least one of the plurality of target PSCell configurations comprises selecting the at least one of the plurality of target PSCell configurations for configuration for the wireless device.

Example C3. The method of any one of Example Embodiments C1 to C2, further comprising: for each of the plurality of target PSCell configurations, determining a respective priority value.

Example C4. The method of Example Embodiment C3, further comprising sorting the plurality of target candidate PSCell configurations based on the respective priority values associated with each of the plurality of target PSCell configurations.

Example C5. The method of any one of Example Embodiments C3 to C4, wherein each priority value indicates a priority level of a particular one of the target candidate PSCell configurations relative to the other target candidate PSCell configurations.

Example C6. The method of any one of Example Embodiments C3 to C5, further comprising: sorting the plurality of target candidate PSCell configurations based on the respective priority values of each target candidate PSCell configuration.

Example C7. The method of any one of Example Embodiments C3 to C6, wherein each priority value comprises an integer number.

Example C8. The method of any one of Example Embodiments C3 to C7, wherein determining the at least one of the plurality of target PSCell configurations comprises selecting the at least one of the plurality of target PSCell configurations based on the respective priority values.

Example C9. The method of any one of Example Embodiments C to C8, wherein the indication of the plurality of target candidate PSCell configurations comprises a prioritized listing of the plurality of target candidate PSCell configurations, and wherein determining the at least one of the plurality of target PSCell configurations comprises selecting the at least one of the plurality of target PSCell configurations based on the prioritized listing.

Example C10. The method of Example embodiment C9, wherein: a first target candidate PSCell configuration with a highest priority is listed first in the prioritized listing of the plurality of target candidate PSCell configurations, and a second target candidate PSCell configuration with a lowest priority is listed last in the prioritized listing of the plurality of target candidate PSCell configurations.

Example C11. The method of Example embodiment C9, wherein: a first target candidate PSCell configuration with a lowest priority is listed first in the prioritized listing of the plurality of target candidate PSCell configurations, and a second target candidate PSCell configuration with a highest priority is listed last in the prioritized listing of the plurality of target candidate PSCell configurations.

Example C12. The method of any one of Example Embodiments C1 to C11, wherein determining the at least one of the plurality of target candidate PSCell configurations to configure for the wireless device comprises selecting a number of target candidate PSCell configurations, and wherein the number of target candidate PSCell configurations does not exceed a maximum number of target candidate PSCell configurations.

Example C13. The method of Example Embodiment C12, wherein a number of the plurality of target candidate PSCell configurations exceeds the maximum number of target PSCell configurations, and the method further comprises cancelling at least one of the target candidate PSCell configurations.

Example C14. The method of Example Embodiment C13, wherein the at least one of the target candidate PSCell configurations that is cancelled is associated with at least one lower priority value.

Example C15. The method of Example Embodiment C13, wherein the at least one of the target candidate PSCell configurations that is cancelled is associated with at least one priority value that is lower than a threshold.

Example C16. The method of any one of Example Embodiments C13 to C16, further comprising transmitting an indication of the at least one of the target candidate PSCell configurations that is cancelled to the SN.

Example C17. The method of any one of Example Embodiments C1 to C16, further comprising: transmitting, to the second network node, a SN addition request, and wherein the indication of the plurality of target candidate PSCell configurations are received in response to the SN addition request.

Example C18. The method of Example Embodiment C17, wherein the SN addition request comprises at least one of: a number of requested PSCells to be configured by the second network node; and a maximum number of PSCells to be configured by the second network node.

Example C19. The method of Example Embodiment C18, wherein the number of requested PSCells and/or the maximum number of PSCells to be configured comprise at least one integer.

Example C20. The method of Example Embodiment C17, wherein the SN addition request comprises at least one measurement, and wherein each measurement is associated with a cell, wherein a number of measurements included in the SN addition request indicates at least one of: a number of requested PSCells to be configured by the second network node; and a maximum number of PSCells to be configured by the second network node.

Example C21. The method of any one of Example Embodiments C17 to C20, wherein the SN addition request comprises a conditional SN addition request comprising an indication of a conditional PSCell change.

Example C22. The method of Example Embodiment C21, wherein the conditional PSCell change comprises a MN-initiated conditional PSCell change (CPC).

Example C23. The method of Example Embodiment C21, further comprising receiving a SN change request from a third network node operating as a source SN, and wherein the conditional PSCell change request is transmitted to the second network node in response to receiving the SN change request.

Example C24. The method of any one of Example Embodiments C1 to C23, wherein the first network node comprises a gNodeB.

Example C25. A network node comprising processing circuitry configured to perform any of the methods of Example Embodiments C1 to C24.

Example C26. A computer program comprising instructions which when executed on a computer perform any of the methods of Example Embodiments C1 to C24.

Example C27. A computer program product comprising computer program, the computer program comprising instructions which when executed on a computer perform any of the methods of Example Embodiments C1 to C24.

Example C28. A non-transitory computer readable medium storing instructions which when executed by a computer perform any of the methods of Example Embodiments C1 to C24.

### Group D Embodiments

Example D1. A method by a first network node operating as a target secondary node (SN) comprises: receiving, from a second network node operating as a master node (MN), a SN addition request; in response to the SN addition request, transmitting, to the second network node, a message comprising: an indication of a plurality of target candidate primary secondary cell (PSCell) configurations to configure for a wireless device, and an indication a priority of each of the plurality of target candidate PSCell configurations.

Example D2. The method of Example Embodiment D1, wherein the indication of the priority of each of the plurality of target candidate PSCell configurations comprises a priority value for each of the plurality of target candidate PSCell configurations.

Example D3. The method of Example Embodiment D2, wherein each priority value indicates a priority level of a particular one of the target candidate PSCell configurations relative to the other target candidate PSCell configurations.

Example D4. The method of any one of Example Embodiments D2 to D3, wherein each priority value comprises an integer number.

Example D5. The method of Example Embodiment D1, wherein the indication of the priority of each of the plurality of target candidate PSCell configurations comprises a prioritized listing of the plurality of target candidate PSCell configurations.

Example D6. The method of Example embodiment D5, wherein: a first target candidate PSCell configuration with a highest priority is listed first in the prioritized listing of the plurality of target candidate PSCell configurations, and a second target candidate PSCell configuration with a lowest priority is listed last in the prioritized listing of the plurality of target candidate PSCell configurations.

Example D7. The method of Example embodiment D5, wherein: a first target candidate PSCell configuration with a lowest priority is listed first in the prioritized listing of the plurality of target candidate PSCell configurations, and a second target candidate PSCell configuration with a highest priority is listed last in the prioritized listing of the plurality of target candidate PSCell configurations.

Example D8. The method of any one of Example Embodiments D1 to D7, further comprising receiving from the second network node a message cancelling at least one of the target candidate PSCell configurations.

Example D9. The method of Example Embodiment D8, wherein the at least one of the target candidate PSCell configurations that is cancelled is associated with at least one lower priority value.

Example D10. The method of Example Embodiment D8, wherein the at least one of the target candidate PSCell configurations that is cancelled is associated with at least one priority value that is lower than a threshold.

Example D11. The method of any one of Example Embodiments D1 to D10, wherein the SN addition request comprises at least one of: a number of requested PSCells to be configured by the second network node; and a maximum number of PSCells to be configured by the second network node.

Example D12. The method of Example Embodiment D11, wherein the number of requested PSCells and/or the maximum number of PSCells to be configured comprise at least one integer.

Example D13. The method of any one of Example Embodiments D1 to D10, wherein the SN addition request comprises at least one measurement, and wherein each measurement is associated with a cell, wherein a number of measurements included in the SN addition request indicates at least one of: a number of requested PSCells to be configured by the second network node; and a maximum number of PSCells to be configured by the second network node.

Example D14. The method of any one of Example Embodiments D1 to D13, wherein the SN addition request comprises a conditional SN addition request comprising an indication of a conditional PSCell change.

Example D15. The method of Example Embodiment D14, wherein the conditional PSCell change comprises a MN-initiated conditional PSCell change (CPC).

Example D16. The method of Example Embodiment D14, further comprising receiving a SN change request from a third network node operating as a source SN, and wherein the conditional PSCell change request is transmitted to the second network node in response to receiving the SN change request.

Example D17. The method of any one of Example Embodiments D1 to D16, wherein the first network node comprises a gNodeB.

Example D18. A network node comprising processing circuitry configured to perform any of the methods of Example Embodiments D1 to D17.

Example D19. A computer program comprising instructions which when executed on a computer perform any of the methods of Example Embodiments D1 to D17.

Example D20. A computer program product comprising computer program, the computer program comprising instructions which when executed on a computer perform any of the methods of Example Embodiments D1 to D17.

Example D21. A non-transitory computer readable medium storing instructions which when executed by a computer perform any of the methods of Example Embodiments D1 to D17.

### Group E Example Embodiments

Example E1. A network node comprising: processing circuitry configured to perform any of the steps of any of the Group A, Group B, Group C, and Group D Example Embodiments; power supply circuitry configured to supply power to the wireless device.

Example E2. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group A, Group B, Group C, and Group D Example Embodiments.

Example E3. The communication system of the pervious embodiment further including the network node.

Example E4. The communication system of the previous 2 embodiments, further including the wireless device, wherein the wireless device is configured to communicate with the network node.

Example D5. The communication system of the previous 3 embodiments, wherein: the processing circuitry of the host computer is configured to execute a host application, thereby providing the user data; and the wireless device comprises processing circuitry configured to execute a client application associated with the host application.

Example D6. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group A, Group B, Group C, and Group D Example Embodiments.

Example D7. The method of the previous embodiment, further comprising, at the network node, transmitting the user data.

Example D8. The method of the previous 2 embodiments, wherein the user data is provided at the host computer by executing a host application, the method further comprising, at the wireless device, executing a client application associated with the host application.

Example D9. A wireless device configured to communicate with a network node, the wireless device comprising a radio interface and processing circuitry configured to performs the of the previous 3 embodiments.

Example D10. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group A, Group B, Group C, and Group D Example Embodiments.

Example D11. The communication system of the previous embodiment further including the network node.

Example D12. The communication system of the previous 2 embodiments, further including the wireless device, wherein the wireless device is configured to communicate with the network node.

Example D13. The communication system of the previous 3 embodiments, wherein: the processing circuitry of the host computer is configured to execute a host application; the wireless device is configured to execute a client application associated with the host application, thereby providing the user data to be received by the host computer.

Example D14. The method of any of the previous embodiments, wherein the network node comprises a base station.

Example D15. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a master node, MN, comprises:
transmitting, to a target secondary node, T-SN, a request message requesting the addition or modification of the T-SN, the message indicating at least one of:
a number of requested primary secondary cells, PSCells, to be configured by the T-SN; and
a maximum number of PSCells to be configured by the T-SN; and
receiving, from the T-SN, an indication of a plurality of target candidate PSCell configurations to configure for a wireless device.

2. The method of claim 1, wherein the plurality of target candidate PSCell configurations does not exceed the number of requested PSCells to be configured by the T-SN and/or the maximum number of PSCells to be configured by the T-SN.

3. The method of claim 1, further comprising selecting at least one of the plurality of target PSCell configurations for configuration for the wireless device.

4. The method of claim 3, wherein selecting the at least one of the plurality of target PSCell configuration comprises:
for each of the plurality of target PSCell configurations, determining a respective priority value; and
selecting the at least one of the plurality of target PSCell configurations based on the respective priority values.

5. The method of claim 1, wherein the indication of the plurality of target candidate PSCell configurations comprises a prioritized listing of the plurality of target candidate PSCell configurations, and the method further comprises selecting the at least one of the plurality of target PSCell configurations based on the prioritized listing.

6. The method of claim 1, further comprising selecting a number of target candidate PSCell configurations from the plurality of target candidate PSCell configurations, and wherein the number of target candidate PSCell configurations does not exceed a maximum number of target candidate PSCell configurations.

7. The method of claim 1, wherein a number of the plurality of target candidate PSCell configurations exceeds the maximum number of target PSCell configurations, and the method further comprises cancelling at least one of the target candidate PSCell configurations.

8. The method of claim 7, further comprising transmitting, to the SN, an indication of the at least one of the target candidate PSCell configurations that is cancelled.

9. The method of claim 8, wherein the SN addition request comprises at least one measurement, and wherein each measurement is associated with a cell.

10. The method of claim 1, wherein the message comprises:
a conditional SN addition request comprising an indication of a MN-initiated conditional PSCell change, or
a SN change request from a source SN.

11. A method by a target secondary node, T-SN, comprises:
receiving, from a master node, MN, a message requesting the addition or modification of the T-SN, the message indicating at least one of:
a number of requested primary secondary cells, PSCells, to be configured by the T-SN; and
a maximum number of PSCells to be configured by the T-SN:
in response to the message, transmitting, to the MN, an indication of a plurality of target candidate PSCell configurations to configure for a wireless device.

12. The method of claim 11, wherein the plurality of target candidate PSCell configurations does not exceed the number of requested PSCells to be configured by the T-SN and/or the maximum number of PSCells to be configured by the T-SN.

13. The method of claim 11, wherein the indication of the plurality of target candidate PSCell configurations comprises at least one of:
an indication a priority of each of the plurality of target candidate PSCell configurations, and
a prioritized listing of the plurality of target candidate PSCell configurations.

14. The method of claim 11 further comprising receiving from the MN a message cancelling at least one of the plurality of target candidate PSCell configurations.

15. The method of claim 14, wherein the at least one of the target candidate PSCell configurations that is cancelled is associated with at least one lower priority value.

16. The method of claim 11 wherein the message comprises at least one measurement, and wherein each measurement is associated with a cell.

17. The method of claim 11, wherein the message comprises:
a conditional SN addition request comprising an indication of a MN-initiated conditional PSCell change, or
a SN change request from a source SN.

18.-29. (canceled)

30. A master node, MN, adapted to:
transmit, to a target secondary node, T-SN, a request message requesting the addition or modification of the T-SN, the message indicating at least one of:
a number of requested PSCells to be configured by the T-SN; and
a maximum number of PSCells to be configured by the T-SN; and
receive, from the T-SN, an indication of a plurality of target candidate primary secondary cell (PSCell) configurations to configure for a wireless device.

31. The MN of claim 30, wherein the plurality of target candidate PSCell configurations does not exceed the number of requested PSCells to be configured by the T-SN and/or the maximum number of PSCells to be configured by the T-SN.

32. A target secondary node, T-SN, adapted to:
receive, from a master node, MN, a message requesting the addition or modification of the target secondary node, the message indicating at least one of:
a number of requested PSCells to be configured by the T-SN; and
a maximum number of PSCells to be configured by the T-SN;
in response to the message, transmit, to the MN, an indication of a plurality of target candidate primary secondary cell, PSCell, configurations to configure for a wireless device.

33.-37.1. (canceled)
